(19) United States
(12) Patent Application Publication
(10) Pub. No.: US 2026/0265283 A1
(43) Pub. Date: Sep. 10, 2026

(54) ASYMMETRICAL HAFNIUM METALLOCENES

(71) Applicant: Dow Global Technologies LLC, Midland, MI (US)

(72) Inventors: Rhett A. Baillie, Missouri City, TX (US); David M. Pearson, Lake Jackson, TX (US); Mahsa McDougal, Pearland, TX (US); Angela I. Padilla-Acevedo, Bartlesville, OK (US); Philip P. Fontaine, Pearland, TX (US); Kurt F. Hirsekorn, Sugar Land, TX (US); Roger L. Kuhlman, Lake Jackson, TX (US)

(21) Appl. No.: 18/873,523

(22) PCT Filed: Aug. 4, 2023
(86) PCT No.: PCT/US2023/029494

§ 371 Date: Dec. 10, 2024

Related U.S. Application Data
(60) Provisional application No. 63/395,376, filed on Aug. 5, 2022.

(51) Int. Cl. C07F 17/00; B01J 31/22; C08F 4/6592; C08F 210/16

(52) U.S. Cl. CPC C07F 17/00; B01J 31/2295; C08F 4/65925; C08F 210/16; B01J 2231/12; B01J 2531/49

(57) ABSTRACT

Embodiments of the present disclosure are directed towards asymmetrical hafnium metallocenes, compositions including those asymmetrical hafnium metallocenes, and methods utilizing compositions including the asymmetrical hafnium metallocenes.

### FIELD OF DISCLOSURE

Embodiments of the present disclosure are directed towards asymmetrical hafnium metallocenes, catalyst compositions including asymmetrical hafnium metallocenes, methods of making and using same, and polyolefins made thereby.

### BACKGROUND

Metallocenes can be used in various applications, including as polymerization catalysts. Polymers may be utilized for a number of products including films, among others. Polymers can be formed by reacting one or more types of monomer in a polymerization reaction. There is continued focus in the industry on developing new and improved materials and/or processes that may be utilized to form polymers.

### SUMMARY

The present disclosure provides various embodiments, including the following.

An asymmetrical hafnium metallocene represented by structure (I):

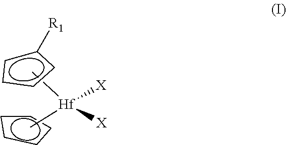

wherein R¹ is a (C₁-C₈)alkyl; and each X is independently a leaving group.

A metallocene catalyst composition comprising the asymmetrical hafnium metallocene and an activator.

A method of making the metallocene catalyst composition, the method comprising contacting the asymmetrical hafnium metallocene with the activator.

A method of making a polyolefin polymer, the method comprising polymerizing at least one olefin monomer with the metallocene catalyst composition to make the polyolefin polymer.

### BRIEF DESCRIPTION OF THE DRAWINGS

FIG. 1 shows data plots utilized to determine molecular weight comonomer distribution index (MWCDI) in accordance a number of embodiments of the present disclosure.

FIG. 2 shows data plots utilized to determine molecular weight comonomer distribution index (MWCDI) in accordance a number of embodiments of the present disclosure.

FIG. 3A shows data plots utilized to determine molecular weight comonomer distribution index (MWCDI) in accordance a number of embodiments of the present disclosure.

FIG. 3B shows data plots utilized to determine molecular weight comonomer distribution index (MWCDI) in accordance a number of embodiments of the present disclosure.

FIG. 4 shows data plots utilized to determine molecular weight comonomer distribution index (MWCDI) in accordance a number of embodiments of the present disclosure.

FIG. 5 shows data plots utilized to determine molecular weight comonomer distribution index (MWCDI) in accordance a number of embodiments of the present disclosure.

FIG. 6 shows data plots of the molecular weight comonomer distribution index (MWCDI) vs density in accordance a number of embodiments of the present disclosure.

FIG. 7 shows data plots of the molecular weight comonomer distribution index (MWCDI) vs density in accordance a number of embodiments of the present disclosure.

### DETAILED DESCRIPTION

Asymmetrical hafnium metallocenes are discussed herein. Advantageously, these asymmetrical metallocenes can be utilized to make catalyst compositions, for instance. These catalyst compositions can be utilized to make polymers having an improved, i.e., greater, molecular weight comonomer distribution index (MWCDI) as compared to other polymers, made from other metallocenes. These polymers are desirable for a number of applications, including films, among others. As such, providing an improved MWCDI is advantageous. Such polymers are advantageous for a number of applications.

The asymmetrical hafnium metallocenes can be represented by structure (I):

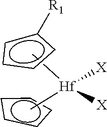

wherein: R¹ is a (C₁-C₈)alkyl; and each X is independently a leaving group. As shown in structure (I), the upper cyclopentadienyl ring is substituted with the R¹ group, and the lower cyclopentadienyl ring is unsubstituted. As one cyclopentadienyl ring is substituted with the R¹ group and the other cyclopentadienyl ring is unsubstituted, the metallocenes can be referred to as asymmetrical metallocenes.

One or more embodiments of the present disclosure provide that R¹ is a (C₁-C₈)alkyl. One or more embodiments of the present disclosure provide that R¹ is a (C₁-C₇)alkyl. One or more embodiments of the present disclosure provide that R¹ is a (C₁-C₆)alkyl. One or more embodiments of the present disclosure provide that R¹ is a (C₂-C₅)alkyl. One or more embodiments of the present disclosure provide that R¹ is a (C₃-C₄)alkyl. One or more embodiments of the present disclosure provide that R¹ is a (C₃)alkyl. The (C₃)alkyl may be branched or linear. As used herein “Pr” and “n-Pr” refer to —CH₂CH₂CH₃. One or more embodiments of the present disclosure provide that R¹ is a (C₄)alkyl. The (C₄)alkyl may be an isobutyl substituent.

Embodiments of the present disclosure provide that X is a leaving group. One or more embodiments provide that X is selected from alkyls, aryls, hydridos, and halogens. One or more embodiments provide that X is selected from a halogen, (C₁-C₅)alkyl, CH₂SiMe₃, and benzyl. One or more embodiments provide that X is selected from alkyls and halogens. One or more embodiments provide that X is Cl. One or more embodiments provide that X is methyl.

Examples of X include halogen ions, hydrides, (C₁ to C₁₂)alkyls, (C₂ to C₁₂)alkenyls, (C₆ to C₁₂)aryls, (C₇ to C₂₀)alkylaryls, (C₁ to C₁₂)alkoxys, (C₆ to C₁₆)aryloxys, (C₇ to C₈)alkylaryloxys, (C₁ to C₁₂)fluoroalkyls, (C₆ to C₁₂)fluoroaryls, and (C₁ to C₁₂)heteroatom-containing hydrocarbons and substituted derivatives thereof; one or more embodiments include hydrides, halogen ions, (C₁ to C₆)alkyls, (C₂ to C₆) alkenyls, (C₇ to C₁₈)alkylaryls, (C₁ to C₆)alkoxys, (C₆ to C₁₄)aryloxys, (C₇ to C₁₆) alkylaryloxys, (C₁ to C₆)alkylcarboxylates, (C₁ to C₆)fluorinated alkylcarboxylates, (C₆ to C₁₂)arylcarboxylates, (C₇ to C₁₈)alkylarylcarboxylates, (C₁ to C₆)fluoroalkyls, (C₂ to C₆)fluoroalkenyls, and (C₇ to C₁₈)fluoroalkylaryls; one or more embodiments include hydride, chloride, fluoride, methyl, phenyl, phenoxy, benzoxy, tosyl, fluoromethyls and fluorophenyls; one or more embodiments include (C₁ to C₁₂)alkyls, (C₂ to C₁₂)alkenyls, (C₆ to C₁₂)aryls, (C₇ to C₂₀)alkylaryls, substituted (C₁ to C₁₂)alkyls, substituted (C₆ to C₁₂)aryls, substituted (C₇ to C₂₀)alkylaryls, and (C₁ to C₁₂)heteroatom-containing alkyls, (C₁ to C₁₂)heteroatom-containing aryls, and (C₁ to C₁₂)heteroatom-containing alkylaryls; one or more embodiments include chloride, fluoride, (C₁ to C₆)alkyls, (C₂ to C₆)alkenyls, (C₇ to C₁₈)alkylaryls, halogenated (C₁ to C₆)alkyls, halogenated (C₂ to C₆) alkenyls, and halogenated (C₇ to C₁₈)alkylaryls; one or more embodiments include fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls).

Other non-limiting examples of X groups include amines, phosphines, ethers, carboxylates, dienes, hydrocarbon radicals having from 1 to 20 carbon atoms, fluorinated hydrocarbon radicals, e.g., —C₆F₅ (pentafluorophenyl), fluorinated alkylcarboxylates, e.g., CF₃C(O)O—, hydrides, halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, and dimethylphosphide radicals, among others. In one embodiment, two or more X's form a part of a fused ring or ring system. In one or more embodiments, X can be a leaving group selected from the group consisting of chloride ions, bromide ions, (C₁ to C₁₀)alkyls, (C₂ to C₁₂)alkenyls, carboxylates, acetylacetonates, and alkoxides. In one or more embodiments, X is methyl.

The asymmetrical hafnium metallocenes discussed herein can be made by contacting a hafnium complex with an alkali metal complex to make the asymmetrical hafnium metallocenes. The asymmetrical hafnium metallocenes discussed herein can be made by processes, e.g., with conventional solvents, reaction conditions, reaction times, and isolation procedures, utilized for making known metallocenes.

The alkali metal complex can be represented by one of the following structures:

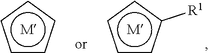

wherein M′ is lithium, sodium, or potassium and R¹ is as defined as discussed herein.

One or more embodiments provide that the hafnium complex can be represented by one the following structures:

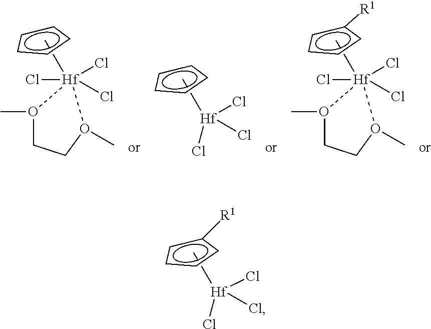

wherein R¹ is as defined as discussed herein.

One or more embodiments provide that a method of making the asymmetrical metallocene, e.g., where each X is Cl, comprises contacting the asymmetrical metallocene with two mole equivalents of an organomagnesium halide of formula RMg(halide) or one mole equivalent of R₂Mg, wherein R is (C₁-C₅)alkyl, CH₂SiMe₃, or benzyl; and the halide is Cl or Br, to make the asymmetrical metallocene of structure (I) wherein each X is a (C₁-C₅)alkyl, CH₂SiMe₃, or benzyl. One or more embodiments provide X is a (C₁-C₅)alkyl, CH₂SiMe₃, or benzyl. As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted.

As used herein, an “alkyl” includes linear, branched and cyclic paraffin radicals that are deficient by one hydrogen. Thus, for example, CH₃ (“methyl”) and CH₂CH₃ (“ethyl”) are examples of alkyls.

As used herein, an “alkenyl” includes linear, branched and cyclic olefin radicals that are deficient by one hydrogen; alkynyl radicals include linear, branched and cyclic acetylene radicals deficient by one hydrogen radical.

As used herein, “aryl” groups include phenyl, naphthyl, pyridyl and other radicals whose molecules have the ring structure characteristic of benzene, naphthylene, phenanthrene, anthracene, etc. It is understood that an “aryl’ group can be a C₆ to C₂₀ aryl group. For example, a C₆H₅ aromatic structure is an “phenyl”, a C₆H₄ 2 aromatic structure is an “phenylene”. An “arylalkyl” group is an alkyl group having an aryl group pendant therefrom. It is understood that an “aralkyl” group can be a (C₇ to C₂₀ aralkyl group. An “alkylaryl” is an aryl group having one or more alkyl groups pendant therefrom.

As used herein, an “alkylene” includes linear, branched and cyclic hydrocarbon radicals deficient by two hydrogens. Thus, CH₂ (“methylene”) and CH₂CH₂ (“ethylene”) are examples of alkylene groups. Other groups deficient by two hydrogen radicals include “arylene” and “alkenylene”.

As used herein, the term “heteroatom” includes any atom selected from the group consisting of B, Al, Si, Ge, N, P, O, and S. A “heteroatom-containing group” is a hydrocarbon radical that contains a heteroatom and may contain one or more of the same or different heteroatoms, and from 1 to 3 heteroatoms in a particular embodiment. Non-limiting examples of heteroatom-containing groups include radicals (monoradicals and diradicals) of imines, amines, oxides, phosphines, ethers, ketones, oxoazolines heterocyclics, oxazolines, and thioethers.

As used herein, the term “substituted” means that one or more hydrogen atoms in a parent structure has been independently replaced by a substituent atom or group.

The asymmetrical hafnium metallocenes discussed herein can be utilized to make catalyst compositions. These compositions include the asymmetrical hafnium metallocenes discussed herein and an activator. One or more embodiments provide that the activator is an alkylaluminoxane such as methylaluminoxane. As used herein, “activator” refers to any compound or combination of compounds, supported, or unsupported, which can activate a complex or a catalyst component, such as by creating a cationic species of the catalyst component. For example, this can include the abstraction of at least one leaving group, e.g., the “X” groups described herein, from the metal center of the complex/catalyst component, e.g., the asymmetrical hafnium metallocene of Structure (I). The activator may also be referred to as a “co-catalyst”. As used herein, “leaving group” refers to one or more chemical moieties bound to a metal atom and that can be abstracted by an activator, thus producing a species active towards olefin polymerization. Various catalyst compositions, e.g., olefin polymerization catalyst compositions, are known in the art and different known catalyst composition components may be utilized. Various amounts of known catalyst composition components may be utilized for different applications.

The asymmetrical hafnium metallocenes discussed herein can be utilized to make spray-dried compositions. As used herein, “spray-dried composition” refers to a composition that includes a number of components that have undergone a spray-drying process. Various spray-drying process are known in the art and are suitable for forming the spray-dried compositions disclosed herein. One or more embodiments provide that the spray-dried composition comprises a trim composition.

In one or more embodiments, the spray-drying process may comprise atomizing a composition including the asymmetrical hafnium metallocene discussed herein. A number of other known components may be utilized in the spray-drying process. An atomizer, such as an atomizing nozzle or a centrifugal high speed disc, for example, may be used to create a spray or dispersion of droplets of the composition. The droplets of the composition may then be rapidly dried by contact with an inert drying gas. The inert drying gas may be any gas that is non-reactive under the conditions employed during atomization, such as nitrogen, for example. The inert drying gas may meet the composition at the atomizer, which produces a droplet stream on a continuous basis. Dried particles of the composition may be trapped out of the process in a separator, such as a cyclone, for example, which can separate solids formed from a gaseous mixture of the drying gas, solvent, and other volatile components.

A spray-dried composition may have the form of a free-flowing powder, for instance. After the spray-drying process, the spray-dried composition and a number of known components may be utilized to form a slurry. The spray-dried composition may be utilized with a diluent to form a slurry suitable for use in olefin polymerization, for example. In one or more embodiments, the slurry may be combined with one or more additional catalysts or other known components prior to delivery into a polymerization reactor.

In one or more embodiments, the spray-dried composition may be formed by contacting a spray dried activator particle, such as spray dried MAO, with a solution of the asymmetrical hafnium metallocene discussed herein. Such a solution typically may be made in an inert hydrocarbon solvent, for instance, and is sometimes called a trim solution. Such a spray-dried composition comprised of contacting a trim solution of the asymmetrical hafnium metallocene with a spray dried activator particle, such as spray-dried MAO, may be made in situ in a feed line heading into a gas phase polymerization reactor by contacting the trim solution with a slurry, typically in mineral oil, of the spray-dried activator particle.

Various spray-drying conditions may be utilized for different applications. For instance, the spray-drying process may utilize a drying temperature from 75 to 185° C. Other drying temperatures are possible, where the temperature can depend on the metallocene and activator particle. Various sizes of orifices of the atomizing nozzle employed during the spray-drying process may be utilized to obtain different particle sizes. Alternatively, for other types of atomizers such as discs, rotational speed, disc size, and number/size of holes may be adjusted to obtain different particle sizes. One or more embodiments provide that a filler may be utilized in the spray-drying process. Different fillers and amounts thereof may be utilized for various applications.

The asymmetrical hafnium metallocenes discussed herein, e.g., catalyst compositions, such as the spray-dried hafnium metallocene composition, may be utilized to make a polymer. For instance, the asymmetrical hafnium metallocene may be activated, i.e., with an activator, to make a catalyst. One or more embodiments provide that the spray-dried compositions include an activator. As used herein, “activator” refers to any compound or combination of compounds, supported, or unsupported, which can activate a complex or a catalyst component, such as by creating a cationic species of the catalyst component, e.g., to provide the catalyst. The activator may also be referred to as a “co-catalyst”. The activator can include a Lewis acid or a non-coordinating ionic activator or ionizing activator, or any other compound including Lewis bases, aluminum alkyls, and/or conventional-type co-catalysts. Activators include methylaluminoxane (MAO) and modified methylaluminoxane (MMAO), among others. One or more embodiments provide that the activator is methylaluminoxane. Activating conditions are well known in the art. Known activating conditions may be utilized.

A molar ratio of metal, e.g., aluminum, in the activator to hafnium in the asymmetrical hafnium metallocene may be 1500:1 to 0.5:1, 300:1 to 1:1, or 150:1 to 1:1. One or more embodiments provide that the molar ratio of in the activator to hafnium in the asymmetrical hafnium metallocene is at least 75:1. One or more embodiments provide that the molar ratio of in the activator to hafnium in the asymmetrical hafnium metallocene is at least 100:1. One or more embodiments provide that the molar ratio of in the activator to hafnium in the asymmetrical hafnium metallocene is at least 150:1.

The asymmetrical hafnium metallocene discussed herein, as well as a number of other components, can be supported on the same or separate supports, or one or more of the components may be used in an unsupported form. Utilizing the support may be accomplished by any technique used in the art. One or more embodiments provide that the spray-dry process is utilized. The support may be functionalized. One or more embodiments provide that the spray-dried compositions include a support.

A “support”, which may also be referred to as a “carrier”, refers to any support material, including a porous support material, such as talc, inorganic oxides, and inorganic chlorides. Other support materials include resinous support materials, e.g., polystyrene, functionalized or crosslinked organic supports, such as polystyrene divinyl benzene polyolefins or polymeric compounds, zeolites, clays, or any other organic or inorganic support material and the like, or mixtures thereof.

Support materials include inorganic oxides that include Group 2, 3, 4, 5, 13 or 14 metal oxides. Some preferred supports include silica, fumed silica, alumina, silica-alumina, and mixtures thereof. Some other supports include magnesia, titania, zirconia, magnesium chloride, montmorillonite, phyllosilicate, zeolites, talc, clays, and the like. Also, combinations of these support materials may be used, for example, silica-chromium, silica-alumina, silica-titania and the like. One or more embodiments provide that the support is silica, One or more embodiments provide that the support is hydrophobic fumed silica. One or more embodiments provide that the support is dehydrated silica. Additional support materials may include porous acrylic polymers, nanocomposites, aerogels, spherulites, and polymeric beads. An example of a support is fumed silica available under the trade name Cabosil™ TS-610, or other TS- or TG-series supports, available from Cabot Corporation. Fumed silica is typically a silica with particles 7 to 30 nanometers in size that has been treated with dimethylsilyldichloride such that a majority of the surface hydroxyl groups are capped.

The asymmetrical hafnium metallocenes discussed herein, e.g., the catalyst compositions/spray-dried compositions, and an olefin can be contacted under polymerization conditions to make a polymer, e.g., a polyolefin polymer. The polymerization process may be a solution polymerization process, a suspension polymerization process, a slurry polymerization process, and/or a gas phase polymerization process. The polymerization process may utilize using known equipment and reaction conditions, e.g., known polymerization conditions. The polymerization process is not limited to any specific type of polymerization system. The polymer can be utilized for a number of articles such as films, fibers, nonwoven and/or woven fabrics, extruded articles, and/or molded articles.

One or more embodiments provide that the polymers are made utilizing a gas-phase reactor system. One or more embodiments provide that a single gas-phase reactor, e.g., in contrast to a series of reactors, is utilized. In other words, polymerization reaction occurs in only one reactor. For instance, the polymers can be made utilizing a fluidized bed reactor. Gas-phase reactors are known and known components may be utilized for the fluidized bed reactor.

As used herein an “olefin,” which may be referred to as an “alkene,” refers to a linear, branched, or cyclic compound including carbon and hydrogen and having at least one double bond. As used herein, when a polyolefin, polymer, and/or copolymer is referred to as comprising, e.g., being made from, an olefin, the olefin present in such polymer or copolymer is the polymerized form of the olefin. For example, when a copolymer is said to have an ethylene content of 75 wt % to 95 wt %, it is understood that the polymer unit in the copolymer is derived from ethylene in the polymerization reaction(s) and the derived units are present at 75 wt % to 95 wt %, based upon the total weight of the polymer. A higher α-olefin refers to an α-olefin having 3 or more carbon atoms.

Polyolefins made with the compositions discussed herein can be made from olefin monomers such as ethylene (i.e., polyethylene), or propylene (i.e., polypropylene), among other provided herein, where the polyolefin is a homopolymer made only from the olefin monomer (e.g., made with 100 wt. % ethylene or 100 wt. % propylene). Alternatively, polyolefins made with the compositions discussed herein can made from olefin monomers such as ethylene, i.e., polyethylene, and linear or branched higher alpha-olefin monomers containing 3 to 20 carbon atoms. Examples of higher alpha-olefin monomers include, but are not limited to, propylene, butene, pentene, 1 -hexene, and 1-octene. Examples of polyolefins include ethylene-based polymers, having at least 50 wt % ethylene, including ethylene-1-butene, ethylene-1-hexene, and ethylene-1-octene copolymers, among others. One or more embodiments provide that the polymer can include from 50 to 99.9 wt % of units derived from ethylene based on a total weight of the polymer. All individual values and subranges from 50 to 99.9 wt % are included; for example, the polymer can include from a lower limit of 50, 60, 70, 80, or 90 wt % of units derived from ethylene to an upper limit of 99.9, 99.7, 99.4, 99, 96, 93, 90, or 85 wt % of units derived from ethylene based on the total weight of the polymer. The polymer can include from 0.1 to 50 wt % of units derived from comonomer based on the total weight of the polymer. One or more embodiments provide that ethylene is utilized as a monomer and hexene is utilized as a comonomer.

As mentioned, the polymers made with the compositions disclosed herein can be made in a fluidized bed reactor. The fluidized bed reactor can have a reaction temperature from 10 to 130° C. All individual values and subranges from 10 to 130° C. are included; for example, the fluidized bed reactor can have a reaction temperature from a lower limit of 10, 20, 30, 40, 50, or 55° C. to an upper limit of 130, 120, 110, 100, 90, 80, 70, or 60° C.

The fluidized bed reactor can have an ethylene partial pressure from 30 to 250 pounds per square inch (psi). All individual values and subranges from 30 to 250 are included; for example, the fluidized bed reactor can have an ethylene partial pressure from a lower limit of 30, 45, 60, 75, 85, 90, or 95 psi to an upper limit of 250, 240, 220, 200, 150, or 125 psi.

One or more embodiments provide that ethylene is utilized as a monomer and hexene is utilized as a comonomer. The fluidized bed reactor can have a comonomer to ethylene mole ratio, e.g., C₆/C₂, from 0.0001 to 0.100. All individual values and subranges from 0.0001 to 0.100 are included; for example, the fluidized bed reactor can have a comonomer to ethylene mole ratio from a lower limit of 0.0001, 0.0005, 0.0007, 0.001, 0.0015, 0.002, 0.007, 0.010, 0.016, or 0.024 to an upper limit of 0.100, 0.080, or 0.050. One or more embodiments provide that comonomer is not utilized.

When hydrogen is utilized for a polymerization process, the fluidized bed reactor can have a hydrogen to ethylene mole ratio (H₂/C₂) from 0.00001 to 0.90000, for instance. All individual values and subranges from 0.00001 to 0.90000 are included; for example, the fluidized bed reactor can have a H₂/C₂ from a lower limit of 0.00001, 0.00005, or 0.00008 to an upper limit of 0.90000, 0.500000, 0.10000, 0.01500, 0.00700, or 0.00500. One or more embodiments provide that hydrogen is not utilized.

A number of polymer properties may be determined utilizing Compositional Conventional Gel Permeation Chromatography. For instance, weight average molecular weight (Mw), number average molecular weight (Mn), Z-average molecular weight (Mz), and Mw/Mn (PDI) were determined using a chromatographic system consisted of a PolymerChar GPC-IR (Valencia, Spain) high temperature GPC chromatograph equipped with an internal IR5 infra-red detector (IR5). The autosampler oven compartment was set at 160° C. and the column compartment was set at 150° C. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{polyethylene} = A \times {( {M}_{polystyrene} )}^{B} \qquad ( EQ 1 )$$

where M is the molecular weight, A has a value of 0.4061 and B is equal to 1.0.

A fifth order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° C. under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCONE software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mw}_{( GPC )} = \frac{{\sum }^{i} ( {IR}_{i} / {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {M}_{{polythylene}_{i}}^{2} )}{\sum ( {IR}_{i} * {M}_{{polyethylene}_{i}} )} \qquad ( EQ 4 )$$

To monitor the deviations over time, a flowrate marker (decane) was introduced into each sample via a micropump controlled with the PolymerChar GPC-IR system. This flowrate marker (FM) was used to linearly correct the pump flowrate (Flowrate₍ₙₒₘᵢₙₐₗ₎) for each sample by RV alignment of the respective decane peak within the sample (RV_{(FM Sample)}) to that of the decane peak within the narrow standards calibration (RV_{(FM Calibrated)}). Any changes in the time of the decane marker peak are then assumed to be related to a linear-shift in flowrate (Flowrate_{(effective)}) for the entire run. After calibrating the system based on a flow marker peak, the effective flowrate (with respect to the narrow standards calibration) is calculated as Equation 5. Processing of the flow marker peak was done via the PolymerChar GPCONE Software. Acceptable flowrate correction is such that the effective flowrate should be within +/−0.5% of the nominal flowrate.

$$Flowrate ( effective ) = Flowrate ( nominal ) * ( RV ( FM Calibrated ) / RV ( FM Sample ) ) \qquad ( EQ 5 )$$

IR5 GPC Octene Composition Calibration. A calibration for the IR5 detector rationing was performed using at least ten ethylene-based polymer standards (Octene as comonomer) made by single-site metallocene catalyst from a single reactor in solution process (polyethylene homopolymer and ethylene/octene copolymers) of a narrow SCB distribution and known comonomer content (as measured by ¹³C NMR Method, Qiu et al., Anal. Chem. 2009, 81, 8585-8589), ranging from homopolymer (0 SCB/1000 total C) to approximately 40 SCB/1000 total C, where total C=carbons in backbone+carbons in branches. Each standard had a weight-average molecular weight from 36,000 g/mole to 126,000 g/mole measured by GPC. Each standard had a molecular weight distribution (Mw/Mn) from 2.0 to 2.5. Polymer properties for the SCB standards are shown in Table A.

TABLE A
“Copolymer” Standards

| Wt % | | | | |
|---|---|---|---|---|
| Comonomer | IR5 Area ratio | SCB / 1000 Total C | Mw | Mw/Mn |
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

The “IR5 Area Ratio (or “IR5_{Methyl Channel Area}/IR5_{Measurement Channel Area}”)” of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “Copolymer” standards. A linear fit of the Wt % Comonomer frequency versus the “IR5 Area Ratio” was constructed in the form of the following Equation 6:

$$Wt \% Comonomer = {A}_{0} + [ {A}_{1} \times ( IR {5}_{M e thyl Channel Area} / IR {5}_{Measurement Channel Area} ) \qquad ( EQ 6 )$$

where A₀ is the “Wt % Comonomer” intercept at an “IR5 Area Ratio” of zero, and A₁ is the slope of the “Wt % Comonomer” versus “IR5 Area Ratio” and represents the increase in the Wt % Comonomer as a function of “IR5 Area Ratio.” The IR5 area ratio is equal to the IR5 height ratio for narrow PDI and narrow SCBD standard materials.

Melt Strength measurements were conducted on a Goettfert Rheotens 71.97 (Goettfert Inc., Rock Hill, S. C.), attached to a Goettfert Rheotester 2000 capillary rheometer. The melted sample (approximately 25 to 30 grams) was fed with the Goettfert Rheotester 2000 capillary rheometer, equipped with a flat entrance angle (180 degrees) of length of 30 mm, diameter of 2.0 mm, and an aspect ratio (length/diameter) of 15. After equilibrating the sample at 190° C. for 10 minutes, the piston was run at a constant piston speed of 0.265 mm/second. The standard test temperature was 190° C. The sample was drawn uniaxially to a set of accelerating wheels, located 100 mm below the die, with an acceleration of 2.4 mm/s². The force exerted on the wheels was recorded as a function of the take-up speed of the wheels.

The following conditions were used in the Melt Strength measurements: plunger speed=0.265 mm/second; wheel acceleration=2.4 mm/s; capillary diameter=2.0 mm; capillary length=30 mm; and barrel diameter=12 mm. Melt Strength was reported as the average plateau force (cN) before the strand broke.

The rheology of each composition was analyzed by Dynamic Mechanical Spectroscopy (DMS), using an Advanced Rheometric Expansion System (ARES), equipped with 25 mm stainless steel parallel plates, under a nitrogen purge. A constant temperature dynamic frequency sweep, in the range of 0.1 to 100 rad/s, was performed under nitrogen, at 190° C. (see Tables 9 and 10). A sample of approximately 25 mm diameter×3.3 mm thick was cut from a compression molded plaque (see below). The sample was placed on the lower plate and allowed to equilibrate for five minutes. The plates were then closed to a gap of 2.0 mm, and the sample trimmed to 25 mm in diameter. The sample was allowed to equilibrate at 190° C. for five minutes, before starting the test. The complex viscosity was measured at a constant strain amplitude of 10%. The stress response was analyzed in terms of amplitude and phase, from which the storage modulus (G′), loss modulus (G″), dynamic viscosity r*, and tan delta could be calculated. The Viscosities (V0.1 and V100) were recorded. Note, V0.1 is the complex viscosity at 0.1 rad/s (190° C.), and V100 is the complex viscosity at 100 rad/s (190° C.). The viscosity is reported in Pascal-seconds (Pa·s).

For each composition, samples were prepared by compression molding approximately 2.3 g material, at 190° C. for five minutes, at 10 MPa pressure, in a 2 in. by 3 in. by 3 mm thick TEFLON coated chase, and then quenched between chilled platens (15-20° C.) for two minutes.

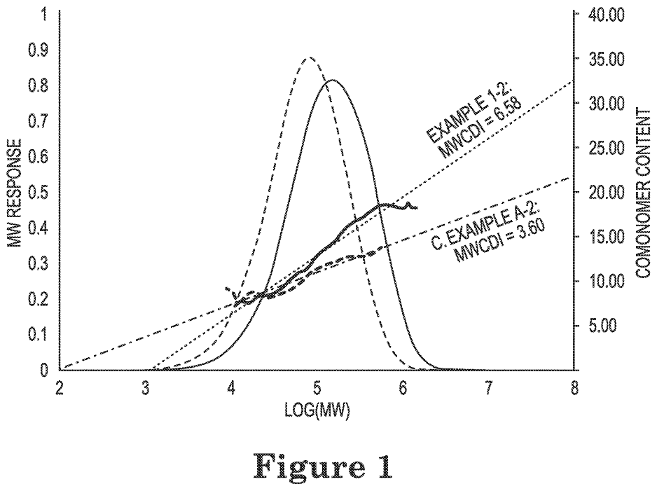

The comonomer distribution, or short chain branching distribution, in an ethylene/α-olefin copolymer can be characterized as either normal (also referred to as having a Zeigler-Natta distribution), reverse, or flat. Several reported methods are utilized to quantify a Broad Orthogonal Composition Distribution (BOCD). Herein, a simple line fit is utilized such that the normal or reverse nature of the comonomer distribution can be quantified by the molecular weight comonomer distribution index (MWCDI), which is the slope of the linear regression of the comonomer distribution taken from a compositional GPC measurement, wherein the x-axis is Log(MW) and the y-axis is weight percent of comonomer. FIG. 1 shows a data plot utilized to determine MWCDI for Example 1-2 (MWCDI=6.58) and a data plot utilized to determine MWCDI for Comparative Example A-2 (MWCDI=3.60), as shown in Table 1 of the Examples section of the present application. A reverse comonomer distribution is defined when the MWCDI>0 and a normal comonomer distribution is defined when the MWCDI<0. When the MWCDI=0 the comonomer distribution is said to be flat. Additionally, the MWCDI quantifies the magnitude of the comonomer distribution. Comparing two polymers that have MWCDI>0, the polymer with the greater MWCDI value is defined to have a greater, i.e., increased, BOCD; in other words, the polymer with the greater MWCDI value has a greater reverse comonomer distribution. For instance, as reported in respectively in Table 1, polymer made with Example 1-2, has an increased BOCD as compared to polymer made with Comparative Example A-2. Polymers with a relatively greater MWCDI, i.e. BOCD, can provide improved physical properties, such as improved film performance, as compared to polymers having a relatively lesser MWCDI.

The polymers made with the compositions disclosed herein can have a MWCDI from 0.10 to 10.00. All individual values and subranges from 0.10 to 10.00 are included; for example, the polymer can have a MWCDI from a lower limit of 0.10, 0.50, or 1.00 to an upper limit of 10.00, 9.00, 8.00, 8.50, or 8.35.

The polymers made with the compositions disclosed herein can have a density from 0.8700 to 0.9700 g/cm³. All individual values and subranges from 0.8700 to 0.9700 g/cm³ are included; for example, the polymer can have a density from a lower limit of 0.8700, 0.9000, 0.9100, 0.9150, 0.9200, or 0.9250 g/cm³ to an upper limit of 0.9700, 0.9600, 0.9500, 0.9450, 0.9350, or 0.9300 g/cm³. Density can be determined by according to ASTM D792.

The polymers made with the compositions disclosed herein can have a melt index (I₂) from 0.0 to 1500 dg/min. I₂ can be determined according to ASTM D1238 (190° C., 2.16 kg). It is noted that I₂ of 0.0 dg/min can be referred to as “no flow”. All individual values and subranges from 0.0 to 1500 dg/min are included; for example, the polymer can have an I₂ from a lower limit of 0.0, 0.05, 0.07, 0.10, 0.20, 0.30, or 0.50 dg/min to an upper limit of 1500, 1200, 1000, 500, 200, 120, or 100 dg/min.

The polymers made with the compositions disclosed herein can have a weight average molecular weight (Mw) from 10,000 to 1,000,000 g/mol. All individual values and subranges from 10,000 to 1,000,000 g/mol are included; for example, the polymers can have an Mw from a lower limit of 10,000, 50,000, or 100,000 g/mol to an upper limit of 1,000,000, 750,000, or 500,000 g/mol. Mw can be determined by gel permeation chromatography (GPC), as is known in the art. GPC is discussed herein.

The polymers made with the compositions disclosed herein can have a number average molecular weight (Mn) from 5,000 to 300,000 g/mol. All individual values and subranges from 5,000 to 300,000 g/mol are included; for example, the polymers can have an Mn from a lower limit of 5,000, 20,000, or 40,000 g/mol to an upper limit of 300,000, 250,000, or 200,000 g/mol. Mn can be determined by GPC.

The polymers made with the compositions disclosed herein can have a Z-average molecular weight (Mz) from 40,000 to 2,000,000 g/mol. All individual values and subranges from 40,000 to 2,000,000 g/mol are included; for example, the polymers can have an Mz from a lower limit of 40,000, 100,000, or 250,000 g/mol to an upper limit of 2,000,000, 1,800,000, or 1,650,000 g/mol. Mz can be determined by GPC.

The polymers made with the compositions disclosed herein can have a weight average molecular weight to number average molecular weight ratio (Mw/Mn) from 2.00 to 6.00. All individual values and subranges from 2.00 to 6.00 are included; for example, the polymers can have an Mw/Mn from a lower limit of 2.00, 2.50, or 3.00 to an upper limit of 6.00, 5.50, or 4.50.

A number of aspects of the present disclosure are provided as follows.

Aspect 1 provides an asymmetrical hafnium metallocene represented by structure (I):

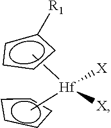

wherein R¹ is a (C₁-C₈)alkyl; and each X is independently a leaving group.

Aspect 2 provides the asymmetrical hafnium metallocene of aspect 1, wherein each X is independently a leaving group selected from a halogen, (C₁-C₅)alkyl, CH₂SiMe₃, and benzyl.

Aspect 3 provides the asymmetrical hafnium metallocene of any one of aspects 2-3, wherein R¹ is a (C₃-C₄)alkyl and each X is Cl or each X is CH₃.

Aspect 4 provides the asymmetrical hafnium metallocene of aspect 1, selected from the group consisting of:
hafnium asymmetrical metallocenes represented by structures (II) to (V):

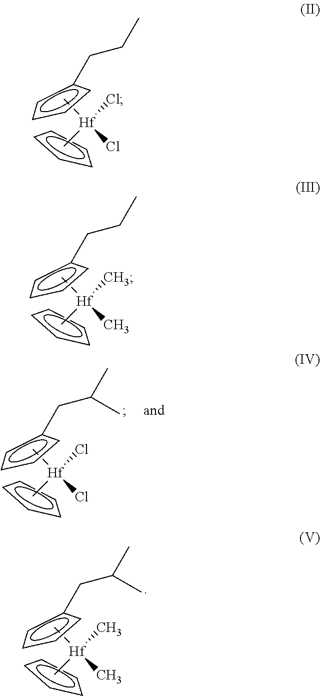

Aspect 5 provides the asymmetrical hafnium metallocene of aspect 1, selected from the group consisting of:
hafnium asymmetrical metallocenes represented by structures (II) to (III):

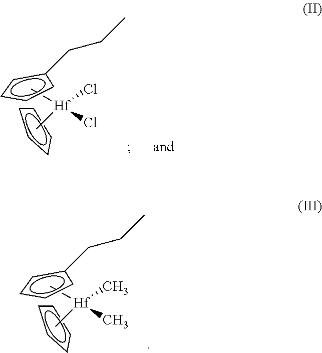

Aspect 6 provides the asymmetrical hafnium metallocene of aspect 1, selected from the group consisting of:
hafnium asymmetrical metallocenes represented by structures (IV) to (V):

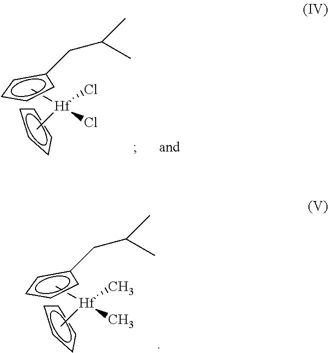

Aspect 7 provides a method of synthesizing the asymmetrical hafnium metallocene of any one of aspects 1-6 wherein each X is Cl, the method comprising either:

contacting a hafnium complex with an alkali metal complex, wherein the alkali metal complex is represented by the following structure:

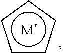

wherein M′ is lithium, sodium, or potassium, and
the hafnium complex is represented by one of the following structures:

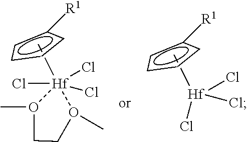

wherein R¹ is as defined in the above aspects; or
contacting a hafnium complex with an alkali metal complex, wherein the alkali metal complex is represented by the following structure:

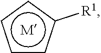

wherein M′ is lithium, sodium, or potassium and R¹ is as defined in the above aspects; and
the hafnium complex is represented by the following structure:

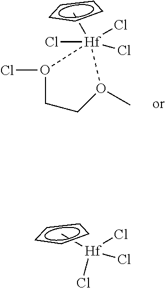

to make the asymmetrical hafnium metallocene.

Aspect 8 provides the method of aspect 7 comprising contacting the asymmetrical hafnium metallocene with two mole equivalents of an organomagnesium halide of formula RMg(halide) or one mole equivalent of R₂Mg, wherein R is (C₁-C₅)alkyl, CH₂SiMe₃, or benzyl; and the halide is Cl or Br, to make the asymmetrical hafnium metallocene of structure (I) wherein each X is (C₁-C₅)alkyl, CH₂SiMe₃, or benzyl.

Aspect 9 provides a metallocene catalyst composition comprising: the asymmetrical hafnium metallocene of any one of aspects 1-6, or the asymmetrical metallocene made by the method of aspect 7 or aspect 8; and an activator (e.g., an alkylaluminoxane such as methylaluminoxane).

Aspect 10 provides the metallocene catalyst composition of aspect 8 further comprising a support (e.g., silica such as a hydrophobic fumed silica or a dehydrated silica).

Aspect 11 provides the metallocene catalyst composition of aspect 10, wherein the composition is a spray-dried metallocene catalyst composition.

Aspect 12 provides a method of making the metallocene catalyst composition of any one of aspects 9 to 11, the method comprising either: contacting the asymmetrical hafnium metallocene with the activator but not the support, to give the metallocene catalyst composition of aspect 9 without a support; or contacting the asymmetrical hafnium metallocene with the activator and the support to give the metallocene catalyst composition of aspect 10 with the support; or contacting the asymmetrical hafnium metallocene with the activator and the support in an inert solvent to give the metallocene catalyst composition of aspects 10 to 11; or contacting the asymmetrical hafnium metallocene with the activator and the support in an inert solvent to give a suspension thereof and spray-drying the suspension to give the spray-dried metallocene catalyst composition of aspect 11; or contacting the asymmetrical hafnium metallocene in an inert solvent with a supported or spray dried activator (or slurry thereof) to give a spray-dried metallocene catalyst composition of aspect 11.

Aspect 13 provides a method of making a polyolefin polymer, the method comprising: polymerizing at least one olefin monomer with either the metallocene catalyst composition of any one of aspects 9-11, or the metallocene catalyst composition made by the method of aspect 12, to make the polyolefin polymer; wherein preferably the at least one olefin monomer comprises ethylene and, optionally, a comonomer selected from the group consisting of propene and a (C₄-C₂₀)alpha-olefin.

Aspect 14 provides the method of aspect 13, wherein the at least one olefin monomer comprises ethylene and the comonomer; and wherein the polyolefin polymer has a molecular weight comonomer distribution index (MWCDI) from 0.10 to 10.00, as measured by the MWCDI Test Method described herein; wherein preferably the comonomer is selected from the group consisting of 1-butene, 1-hexene, and 1-octene.

Aspect 15 provides a polyolefin polymer made by the method of any one of aspects 13-14.

Aspect 16 provides the polyolefin polymer of aspect 15, wherein the polyolefin polymer has MWCDI vs density relationship such that: MWCDI>−133*Density+126.75.

Aspect 17 provides the polyolefin polymer of aspect 15, wherein the polyolefin polymer has MWCDI vs density relationship such that: MWCDI>−157.75*Density+150.62.

Aspect 18 provides a method of making a polyolefin polymer, the method comprising: polymerizing at least one olefin monomer with a spray dried asymmetrical hafnium metallocene catalyst composition to make the polyolefin polymer; wherein at least one olefin monomer comprises ethylene and, optionally, a comonomer selected from the group consisting of propene and a (C₄-C₂₀)alpha-olefin, wherein the polyolefin polymer has a molecular weight comonomer distribution index (MWCDI) from 0.10 to 10.00 and a MWCDI vs density relationship such that: MWCDI>−133*Density+126.75.

Aspect 19 provides the method of aspect 18, wherein the polyolefin polymer has a MWCDI vs density relationship such that: MWCDI>−157.75*Density+150.62.

### Examples

Hafnium complex I: (n-Propylcylopentadienyl)hafnium trichloride, dimethoxyethane adduct, which may be represented by the following structure:

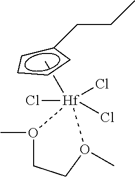

was synthesized as follows. The (n-propylcylopentadienyl)hafnium trichloride, dimethoxyethane adduct was synthesized as follows (e.g., by adapting the procedure described in WO2016/168448A1 by Harlan). Bis-(n-propylcyclopentadienyl) hafnium dichloride was commercially obtained from TCI; bis(n-propylcyclopentadienyl)hafnium dichloride (25.1 g, 54.1 mmol) was heated to 140° C. in a 100 mL round-bottom flask until melted. HfCl₄ (17.5 g, 54.6 mmol) was added to the flask as a solid powder. The contents of the flask were heated at 140° C. for approximately 30 minutes and formed a brown viscous liquid. The 100 mL round bottom flask was attached to a short path distillation apparatus, which consisted of a glass tube (90° bend) that was attached to a Schlenk flask. A vacuum was pulled through a stopcock of the Schlenk flask. Distillation was performed from 105° C. to 110° C. with 0.4 torr vacuum. In approximately one hour, it was observed that most of the material distilled/sublimed into the Schlenk flask or remained in the glass tube. The solid material in the u-tube was scraped out and combined with the material in the Schlenk flask. To this solid was added toluene (50 mL) and dimethoxyethane (50 mL). This was heated to reflux forming a solution, additional toluene (50 mL) was added. Upon cooling colorless needles formed. Pentane (200 mL) was added causing further formation of solid precipitate. The solid was isolated by filtration, washed with pentane (2×50 mL) and dried under vacuum to provide (n-propylcylopentadienyl)hafnium trichloride, dimethoxyethane adduct (42.2 g); cooling the combined supernatant and washings resulted an additional 2.6 g of product that was isolated.

Example 1-1, an asymmetrical hafnium metallocene, which may be represented by the following structure (II):

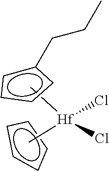

was synthesized as follows. For the above formula, R¹, as previously discussed, is a (C₃)alkyl (n-propyl). In a glove box, (n-propylcyclopentadienyl) hafniumtrichloride dimethoxy ethane adduct (0.75 g, 1.56 mmol) was added to a container (oven-dried 4 oz. glass jar); a teflon-coated stir bar and 40 mL of dry toluene (40 mL) were added to the container and the contents were stirred. The contents were observed to be grey and cloudy. Cyclopentadienyllithium (1 molar equivalent) was slowly added the container; then, the contents of the container were stirred for approximately 12 hours at approximately 20° C. NMR spectra indicated formation of Example 1-1, as well as some unreacted starting material. The contents of the container were further stirred for approximately 120 hours at approximately 20° C.; then, the contents of the container were filtered and volatiles were removed under reduced pressure. The solids were recrystallized from warm hexanes and toluene; the resultant solids (Example 1-1) were isolated (63.9% total yield after recrystallization). 1H and 13C NMR spectra confirmed Example 1-1. ¹H NMR (400 MHz, C₆D₆) δ 5.86 (s, 3H), 5.77-5.72 (m, 2H), 5.57 (t, J=2.7 Hz, 2H), 2.63-2.54 (m, 2H), 1.48-1.35 (m, 2H), 0.80 (t, J=7.3 Hz, 3H). ¹³C NMR (101 MHz, C₆D₆) δ 132.81, 115.78, 114.13, 110.86, 32.38, 24.34, 14.00.

Example 1-2, a spray-dried composition, was made as follows. In a nitrogen-purged glovebox, hydrophobic fumed silica (CABOSIL TS-610; 1.325 grams) and toluene (37.5 grams) were added to a container and mixed, followed by addition of a 10% solution (11 grams) by weight of methylaluminoxane (MAO) in toluene. Then the contents of the container were stirred for approximately 15 minutes. Then, Example 1-1 (0.054 grams) was added to the container and the contents of the container were stirred for approximately 45 minutes. Then, the contents of the container were spray-dried utilizing a Buchi Mini Spray Drier B-290 (185° C. set temperature; 100° C. outlet temperature; 150 rpm pump speed) to provide Example 1-2.

Example 1-3, an asymmetrical hafnium metallocene, which may be represented by the following structure (III):

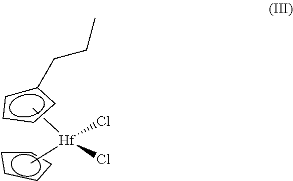

was synthesized as follows.

Example 1-1 (8.5 g, 20.2 mmol) was dissolved in ether (80 mL) in a container. Methylmagnesium bromide (13.4 mL, 3.0 M in Et₂O, 40.3 mmol) was added dropwise via syringe to the contents of the container; then, the contents of the container were stirred for approximately 12 hours at approximately 20° C. Then volatiles were removed by vacuum, and hexane (30 mL) was added to the contents of the container; then the contents were filtered through Celite to remove insoluble byproducts. The contents and Celite filter were washed with additional hexane (30 mL). Removal of solvents in vacuo from the filtrate yielded Example 1-3, which was observed to be an off-white solid (7.11 g, 93%). ¹H NMR (400 MHz, C₆D₆): δ 5.70 (s, 4H), 5.57 (t, J=2.6 Hz, 2H), 5.41 (t, J=2.7 Hz, 2H), 2.33-2.26 (m, 2H), 1.48 (dq, J=14.8, 7.4 Hz, 2H), 0.87 (t, J=7.3 Hz, 3H), −0.30 (s, 6H). ¹³C NMR (101 MHz, C₆D₆): δ 127.08, 110.65, 109.89, 107.39, 36.43, 32.35, 25.22, 14.12.

5-(2-methylpropylidene)cyclopenta-1,3-diene, which may be represented by the following structure:

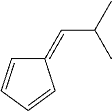

was synthesized as follows. In a glove box, pyrrolidine (1.45 g, 10 mol %) was added to a glass container that contained a solution of isobutyraldehyde (14.6 g, 203 mmol) and cyclopentadiene (13.4 g, 203 mmol) in MeOH—H₂O (200 mL 4/1). The contents of the container were transferred to an ice-cold mixture of brine solution and 10 mol % AcOH in a narrow graduated cylinder. The organic phase was isolated and dried over molecular sieves. The product (5-(2-methylpropylidene)cyclopenta-1,3-diene) was filtered to yield a bright yellow oil, which was subsequently used without further purification (16.0 g, 65%). ¹H NMR (400 MHz, CDCl₃) δ: 6.54 (tdd, J=5.4, 3.8, 2.5 Hz, 2H), 6.51-6.44 (m, 1H), 6.29-6.17 (m, 2H), 3.02 (dp, J=10.0, 6.6 Hz, 1H), 1.15 (d, J=6.6 Hz, 6H). ¹³C NMR (101 MHz, CDCl₃) δ: 149.88, 143.69, 133.08, 130.87, 126.06, 119.36, 30.58, 23.24.

Iso-butylcyclopentadienyl lithium, which may be represented by the following structure:

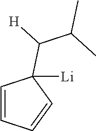

was synthesized as follows.

Et₂O (250 mL) was added to a container. 5-(2 methylpropylidene)cyclopenta-1,3-diene (16.0 g, 133 mmol) was added to the contents of the container while stirring. LiAlH₄ (33 mL, 4 M Et₂O solution) was added dropwise to the contents of the container while stirring. Bubbling was observed. Over the course of the addition a white solid precipitated, a yellow color gradually receded as the LiAlH₄ addition continued. The addition was stopped once the solution became only slightly yellow. The product, iso-butylcyclopentadienyl lithium, observed to be white solid, was collected by filtration, rinsed with Et₂O, and dried under vacuum (13.7 g, 80%).

Hafnium complex II, which may be represented by the following structure:

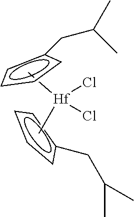

was synthesized as follows.

Iso-butylcyclopentadienyl lithium (0.150 g, 1.17 mmol) and hafnium tetrachloride (0.187 g, 0.585 mmol) were added to a container with THF and stirred for approximately 12 hours at approximately 20° C. Then the contents of the container were concentrated to yield an off-white residue. The residue was extracted with dichloromethane and then filtered. The resulting solution was placed under vacuum to yield hafnium complex II (0.276 g, 96%). ¹H NMR (400 MHz, C₆D₆) δ: 5.83 (t, J=2.7 Hz, 4H), 5.72-5.61 (m, 4H), 2.57 (d, J=7.0 Hz, 4H), 1.62 (dq, J=13.5, 6.8 Hz, 2H), 0.80 (d, J=6.6 Hz, 12H). ¹³C NMR (101 MHz, C₆D₆) δ: 130.67, 116.15, 110.24, 39.50, 30.32, 22.09.

Hafnium complex Ill, which may be represented by the following structure:

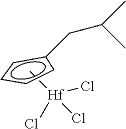

was synthesized as follows.

Hafnium tetrachloride (0.33 g, 1.0 mmol) and hafnium complex II bis(iso-butylcyclopentadienyl)hafnium dichloride (0.50 g, 1.0 mmol)) were combined in a large screw-cap container. The contents of the container evolved into a viscous brown liquid upon heating. A colorless vapor started to appear on the sides of the container at approximately 150° C. The heating was adjusted to 150° C. at that point. A white solid began to form at a colorless vapor line. After approximately 5 minutes, the container was removed from the heat and cooled under a nitrogen atmosphere. A white solid was manually scraped from the container and transferred to a second container. After removing most of the white solid the container was placed under vacuum and reheated to 150° C. for 5 minutes. A second crop of the white solid was obtained and combined with the first set of isolated material to obtain hafnium complex III (0.59 g, 72%). ¹H NMR (400 MHz, C₆D₆) δ 5.81 (t, J=2.7 Hz, 2H), 5.75 (t, J=2.7 Hz, 2H), 2.27 (d, J=7.0 Hz, 3H), 1.35 (dq, J=13.5, 6.7 Hz, 1H), 0.59 (d, J=6.6 Hz, 8H). ¹³C NMR (101 MHz, C₆D₆) δ 134.94, 116.61, 116.04, 38.83, 30.18, 21.67.

Example 2-1, an asymmetrical hafnium metallocene, which may be represented by the following structure:

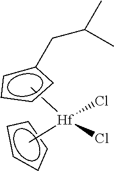

was synthesized as follows. Hafnium complex III (0.100 g, 246 mmol) and cyclopentadienyllithium (0.021 g, 0.246 mmol) were added to a container. Et₂O was then added to the container and contents of the container were stirred for approximately 12 hours at approximately 20° C. The contents of the container were filtered and then concentrated under vacuum to obtain Example 2-1 (0.098 g, 88%). ¹H NMR (400 MHz, C₆D₆) δ 5.79 (t, J=2.7 Hz, 2H), 5.75-5.70 (m, 1H), 5.62 (t, J=2.7 Hz, 1H), 5.60 (t, J=2.7 Hz, 1H), 2.54 (d, J=7.0 Hz, 2H), 2.25 (d, J=2.5 Hz, 1H), 2.18 (s, 3H), 1.60 (dq, J=13.5, 6.7 Hz, 1H), 0.78 (d, J=6.7 Hz, 6H). ¹³C NMR (101 MHz, C₆D₆) δ 116.43, 116.23, 110.71, 110.66, 39.86, 30.71, 22.46.

Example 2-2, a spray-dried composition, was made as follows. In a nitrogen-purged glovebox, hydrophobic fumed silica (CABOSIL TS-610; 0.665 grams) and toluene (19 grams) were added to a container and mixed, followed by addition of a 10% solution (5.5 grams) by weight of methylaluminoxane (MAO) in toluene. Then the contents of the container were stirred for approximately 15 minutes. Then, Example 2-1 (0.022 grams) was added to the container and the contents of the container were stirred for approximately 45 minutes. Then, the contents of the container were spray-dried utilizing a Buchi Mini Spray Drier B-290 (185° C. set temperature; 100° C. outlet temperature; 150 rpm pump speed) to provide Example 2-2.

Comparative Example A-1, a hafnium metallocene having two substituted cyclopentadienyl rings, which may be represented by the following structure:

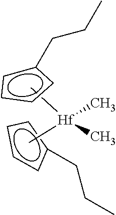

was synthesized as follows. Bis-(n-propylcyclopentadienyl) hafnium dichloride was commercially obtained from TCI; this is readily converted to bis-(n-propylcyclopentadienyl) hafnium dimethyl by someone skilled in the art by reaction with a methylating agent, such as a Grignard reagent, for example, methylmagnesium bromide.

Comparative Example A-2, a spray-dried composition, was made as follows. In a nitrogen-purged glovebox, hydrophobic fumed silica (CABOSIL TS-610; 2.65 grams) and toluene (75 grams) were added to a container and mixed, followed by addition of a 10% solution (22 grams) by weight of methylaluminoxane (MAO) in toluene. Then the contents of the container were stirred for approximately 15 minutes. Then, Comparative Example A-1 (0.105 grams) was added to the container and the contents of the container were stirred for approximately 45 minutes. Then, the contents of the container were spray-dried utilizing a Buchi Mini Spray Drier B-290 (185° C. set temperature; 100° C. outlet temperature; 150 rpm pump speed) to provide Comparative Example A-2.

Comparative Example B-1, a hafnium metallocene having two substituted cyclopentadienyl rings, which may be represented by the following structure:

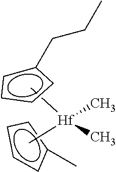

was synthesized as follows. In a glove box, to a glass jar (4 oz.) including dry toluene (40 mL), the (n-propylcylopentadienyl)hafnium trichloride, dimethoxyethane adduct (0.75 grams; 1.56 mmol) was added while stirring with a teflon-coated stir bar. The contents of the jar were observed to be grey and cloudy. Then, methylcyclopentadienyllithium (MeCpLi) (1 molar equivalent) was slowly added to the contents of the jar and the contents of the jar were stirred for approximately 12 hours at room temperature (approximately 20° C.). Then, the contents of the jar were filtered and volatiles were removed from filtrate under reduced pressure to provide Comparative Example B-1 (0.618 g; 91.2%). 1H and 13C NMR spectra confirmed the product. ¹H NMR (400 MHz, C₆D₆) δ 5.80-5.68 (m, 3H), 5.61 (dt, J=5.5, 2.7 Hz, 3H), 2.64-2.55 (m, 2H), 2.17 (d, J=0.6 Hz, 3H), 1.49-1.36 (m, 2H), 0.80 (t, J=7.4 Hz, 3H). ¹³C NMR (101 MHz, C₆D₆) δ 132.51, 116.18, 115.40, 110.75, 110.71, 32.42, 24.39, 15.37, 14.01.

Comparative Example B-2, a spray-dried composition, was made as follows. In a nitrogen-purged glovebox, hydrophobic fumed silica (CABOSIL TS-610; 1.325 grams) and toluene (37.5 grams) were added to a container and mixed, followed by addition of a 10% solution (11 grams) by weight of methylaluminoxane (MAO) in toluene. Then the contents of the container were stirred for approximately 15 minutes. Then, Comparative Example B-1 (0.056 grams) was added to the container and the contents of the container were stirred for approximately 45 minutes. Then, the contents of the container were spray-dried utilizing a Buchi Mini Spray Drier B-290 (185° C. set temperature; 100° C. outlet temperature; 150 rpm pump speed) to provide Comparative Example B-2.

Comparative Example C-1, a spray-dried composition, was made as follows. In a nitrogen-purged glovebox, hydrophobic fumed silica (CABOSIL TS-610; 1.33 grams) and toluene (37.5 grams) were added to a container and mixed, followed by addition of a 10% solution (11 grams) by weight of methylaluminoxane (MAO) in toluene. Then the contents of the container were stirred for approximately 15 minutes. Then, hafnium complex II (0.049 grams) was added to the container and the contents of the container were stirred for approximately 45 minutes. Then, the contents of the container were spray-dried utilizing a Buchi Mini Spray Drier B-290 (185° C. set temperature; 100° C. outlet temperature; 150 rpm pump speed) to provide Comparative Example C-1.

Polymerizations were performed as follows. For respective polymerizations, a lab-scale gas phase polymerization reactor (2-liter, stainless steel autoclave equipped with a variable speed mechanical agitator) was charged with dried NaCl (200 g) and heated to 100° C. under a stream of nitrogen for one hour. Then the reactor was purged with nitrogen, silica supported methylaluminoxane was added as a scavenger to the reactor, the reactor temperature was adjusted to approximately a desired temperature, the reactor was sealed, and the contents of the reactor were stirred. The reactor was preloaded with hydrogen, ethylene, and 1-hexene to a desired pressure. Upon reaching steady state, catalyst was charged into the reactor (at a temperature indicated below) to start polymerization. The reactor temperature was maintained at a desired temperature for the 60-minute polymerization, where hydrogen, C₆/C₂ ratio and ethylene pressure were maintained constant. At the end of the 60-minute polymerization, the reactor was cooled down, vented and opened. The resulting mixture was washed with water and methanol, and dried. Polymerization conditions are reported in Tables 1-4.

A number of properties were determined for polymers respectively made with Example 1-2, Example 2-2, Comparative Example A-2, Comparative Example B-2, and Comparative Example C-1. The results are reported in Tables 1-4. Catalyst productivity (grams polymer/gram catalyst-hour) was determined as a ratio of polymer produced to an amount of catalyst added to the reactor. Melt index (12) was determined according to ASTM D1238 (190° C., 2.16 kg), melt index (15) was determined according to ASTM D1238 (190° C., 5 kg), melt index (121) was determined according to ASTM D1238 (190° C., 21.6 kg). Melt temperatures were determined using a Differential Scanning Calorimetry according to ASTM D 3418-08, with a scan rate of 10° C./min on a sample of 10 mg was used, and the second heating cycle was used to determine Tₘ. M_{w}, Mₙ, M_{z}, M_{w}/Mₙ (PDI), and M_{z}/M_{w} were determined as discussed above in the detailed description. The comonomer content, e.g., 1-hexene, incorporated in the polymers was determined by rapid FT-IR spectroscopy on the dissolved polymer in a GPC measurement as discussed above in the detailed description; molecular weight comonomer distribution index (MWCDI) was determined as discussed herein.

TABLE 1

| | | Comparative | Comparative |
|---|---|---|---|
| | Example | Example | Example |
| | 1-2 | A-2 | B-2 |
| Reaction | 80 | 80 | 80 |
| Temp | | | |
| (° C.) | | | |
| C₆/C₂ | 0.016 | 0.016 | 0.016 |
| H₂/C₂ | 0.0005 | 0.0005 | 0.0005 |
| C₂ | 220 | 220 | 220 |
| Partial | | | |
| Pressure | | | |
| (psi) | | | |
| Catalyst | 10.8 | 10.7 | 10.5 |
| loading | | | |
| (mg) | | | |
| Yield | 24.00 | 113.19 | 37.80 |
| (g) | | | |
| Catalyst | 2,222 | 10,579 | 3,600 |
| productivity | | | |
| Mn | 67,340 | 37,995 | 36,428 |
| Mw | 237,966 | 121,132 | 122,725 |
| Mz | 611,355 | 280,366 | 355,849 |
| Mw/Mn | 3.53 | 3.19 | 3.37 |
| Mz/Mw | 2.57 | 2.31 | 2.74 |
| C₆ | 14.16 | 10.65 | 7.50 |
| (wt %) | | | |
| Melt Index | No Flow | 0.863 | 0.761 |
| (I₂) | | | |
| Melt Index | 0.17 | 2.239 | 2.065 |
| (I₅) | | | |
| Melt Index | 1.286 | 17.497 | 16.020 |
| (I₂₁) | | | |
| Melt Temp | 92.29 | 117.91 | 121.17 |
| (° C.) | | | |
| MWCDI | 6.58 | 3.60 | 5.44 |

The data of Table 1 illustrate that polymer made with Example 1-2 had an improved, i.e., greater, molecular weight comonomer distribution index (MWCDI) as compared to polymer made with both Comparative Example A-2 and Comparative Example B-2. In addition, the polymer made by Example 1-2 had a higher Mw at the same conditions, also shown by having a no flow melt index (I₂) compared to 0.863 and 0.761 for the polymers made by Comparative Examples A-2 and B-2, and a much lower flow index than the polymers made by either comparative example A-2 or B-2. The catalyst Example 1-2 also incorporates more comonomer at the same conditions as comparative examples A-2 and B-2, as the polymer made as a higher wt % hexene than either comparative example.

FIG. 1 shows a data plot utilized to determine MWCDI for polymer made with Example 1-2 (MWCDI=6.58) and a data plot utilized to determine MWCDI for polymer made with Comparative Example A-2 (MWCDI=3.60), as reported in Table 1.

TABLE 2

| | | Comparative | Comparative |
|---|---|---|---|
| | Example | Example | Example |
| | 1-2 | A-2 | B-2 |
| Reaction | 90 | 90 | 90 |
| Temp | | | |
| (° C.) | | | |
| C₆/C₂ | 0.016 | 0.016 | 0.016 |
| H₂/C₂ | 0.0005 | 0.0005 | 0.0005 |
| C₂ | 220 | 220 | 220 |
| Partial | | | |
| Pressure | | | |
| (psi) | | | |
| Catalyst | 10.3 | 10.3 | 10.7 |
| loading | | | |
| (mg) | | | |
| Yield | 15.19 | 94.40 | 43.20 |
| (g) | | | |
| Catalyst | 1,475 | 9,165 | 4,037 |
| productivity | | | |
| Mn | 93,000 | 60,675 | 70,745 |
| Mw | 269,865 | 163,442 | 201,264 |
| Mz | 559,195 | 323,504 | 423,139 |
| Mw/Mn | 2.90 | 2.69 | 2.84 |
| Mz/Mw | 2.07 | 1.98 | 2.10 |
| C₆ | 13.97 | 12.77 | 10.51 |
| (wt %) | | | |
| Melt Index | No Flow | 0.303 | No Flow |
| (I₂) | | | |
| Melt Index | No Flow | 0.737 | 0.301 |
| (I₅) | | | |
| Melt Index | 0.97 | 4.79 | 1.97 |
| (I₂₁) | | | |
| Melt Temp | 76.0 | 99.4 | 104.7 |
| (° C.) | | | |
| MWCDI | 3.03 | 1.67 | 2.37 |

The data of Table 2 illustrate that polymer made with Example 1-2 had an improved, i.e., greater, molecular weight comonomer distribution index (MWCDI) as compared to polymer made with both Comparative Example A-2 and Comparative Example B-2. The polymer made with Example 1-2 also has a higher Mw, also shown by a lower flow index (121) than the polymers made by either comparative example A-2 or B-2. The catalyst Example 1-2 also incorporates more comonomer at the same conditions as comparative examples A-2 and B-2, as the polymer made as a higher wt % hexene than either comparative example.

TABLE 3

| | | Comparative | Comparative |
|---|---|---|---|
| | Example | Example | Example |
| | 2-2 | A-2 | C-1 |
| Reaction | 80 | 80 | 80 |
| Temp | | | |
| (° C.) | | | |
| C₆/C₂ | 0.016 | 0.016 | 0.016 |
| H₂/C₂ | 0.0005 | 0.0005 | 0.0005 |
| C₂ | 220 | 220 | 220 |
| Partial | | | |
| Pressure | | | |
| (psi) | | | |
| Catalyst | 5 | 10 | 5 |
| loading | | | |
| (mg) | | | |
| Yield | 43.6 | 109.9 | 41.8 |
| (g) | | | |
| Catalyst | 7,086 | 10,579 | 6,836 |
| productivity | | | |
| Mn | 84,720 | 37,995 | 57,169 |
| Mw | 268,201 | 121,132 | 156,089 |
| Mz | 910,482 | 280,366 | 832,761 |
| Mw/Mn | 3.17 | 3.19 | 2.73 |
| Mz/Mw | 3.39 | 2.31 | 5.34 |
| C₆ | 15.4 | 10.8 | 16.3 |
| (wt %) | | | |
| Melt Index | No Flow | 0.9 | 0.4 |
| (I₂) | | | |
| Melt Index | No Flow | 2.2 | 0.9 |
| (I₅) | | | |
| Melt Index | 0.32 | 17.5 | 6.3 |
| (I₂₁) | | | |
| Melt Temp | 117.2 | 117.9 | 118.1 |
| (° C.) | | | |
| MWCDI | 7.38 | 3.60 | 5.91 |

The data of Table 3 illustrate that polymer made with Example 2-2 had an improved, i.e., greater, molecular weight comonomer distribution index (MWCDI) as compared to polymer made with both Comparative Example A-2 and Comparative Example C-1. Further, In Tables 3 and 4 Example 2-2 is shown to have a higher Mw at same conditions—this higher Mw capability is a desirable feature of the catalysts disclosed herein.

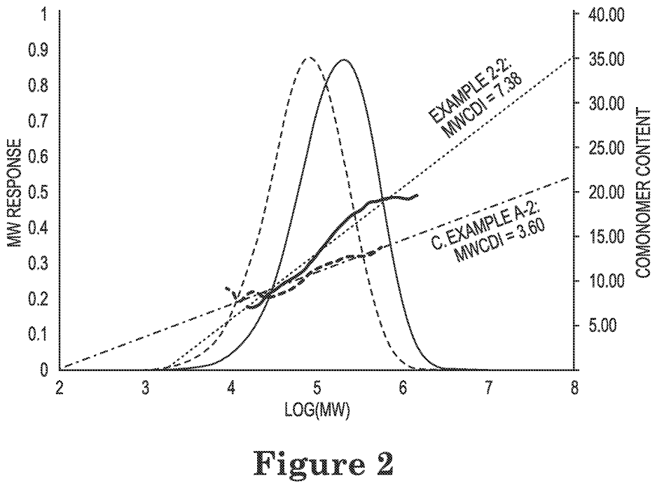

FIG. 2 shows a data plot utilized to determine MWCDI for polymer made with Example 2-2 (MWCDI=7.38) and a data plot utilized to determine MWCDI for polymer made with Comparative Example A-2 (MWCDI=3.60), as reported in Table 3.

TABLE 4

| | | Comparative | Comparative |
|---|---|---|---|
| | Example | Example | Example |
| | 2-2 | A-2 | C-1 |
| Reaction | 90 | 90 | 90 |
| Temp | | | |
| (° C.) | | | |
| C₆/C₂ | 0.016 | 0.016 | 0.016 |
| H₂/C₂ | 0.0005 | 0.0005 | 0.0005 |
| C₂ | 220 | 220 | 220 |
| Partial | | | |
| Pressure | | | |
| (psi) | | | |
| Catalyst | 5 | 10 | 5 |
| loading | | | |
| (mg) | | | |
| Yield | 9.6 | 100.9 | 47.6 |
| (g) | | | |
| Catalyst | 16,783 | 9,165 | 7,888 |
| productivity | | | |
| Mn | 124,009 | 60,675 | 51,796 |
| Mw | 302,363 | 163,442 | 127,647 |
| Mz | 568,474 | 323,504 | 338,808 |
| Mw/Mn | 2.44 | 2.69 | 2.46 |
| Mz/Mw | 1.88 | 1.98 | 2.65 |
| C₆ | 14.6 | 12.9 | 14.6 |
| (wt %) | | | |
| Melt Index | No Flow | 0.3 | 0.7 |
| (I₂) | | | |
| Melt Index | No Flow | 0.7 | 1.6 |
| (I₅) | | | |
| Melt Index | 0.13 | 4.8 | 10.3 |
| (I₂₁) | | | |
| Melt Temp | 95.1 | 99.4 | 97.5 |
| (° C.) | | | |
| MWCDI | 3.04 | 1.67 | 2.86 |

The data of Table 4 illustrate that polymer made with Example 2-2 had an improved, i.e., greater, molecular weight comonomer distribution index (MWCDI) as compared to polymer made with both Comparative Example A-2 and Comparative Example C-1.

Polymers were made utilizing a Gas-Phase Continuous Polymerization Reactor, where a number of the polymerization utilized a trim component (with a concentration of 0.04 wt %), as follows.

Spray dried MAO Slurry (SDMAO)—14 wt % SDMAO, 10 wt % hexane, 76 wt % Hydrobite 380 mineral oil (obtained from Sonneborn, LLC). Spray dried MAO was prepared as a dry powder by adapting the procedure according to U.S. Pat. No. 8,497,330 B2, column 22, lines 48, to 67. The adapted procedure omitted the addition of a metallocene compound; the toluene, methylaluminoxane (MAO may be obtained from AkzoNobel), Cabosil slurry is instead introduced to the atomizing device to produce the SDMAO as a dry powder. Polymerization conditions are reported in Tables 5, 7, and 8.

Example 1-4, a spray-dried composition, was made as follows. In a 13-gallon mix tank 2.38 lbs Cabosil TS-610 hydrophobic fumed silica and 37.0 lbs 10 wt % MAO in toluene, and then 80.0 g of (propylcyclopentadineyl)(cyclopentadienyl)hafnium(IV) dichloride (Example 1-1) were slurried with an additional 20 lbs toluene. The mixture was spray dried with the following operating parameters: inlet temperature 146° C., outlet temperature 84° C., slurry inlet feed of 13 lb/hr, and atomizer speed 20000 rotations per minute (rpm) to give 4.1 lbs of Example 1-4 as a powder.

Example A-3, a spray-dried composition, was made as above (same procedure to Example 1-4) and adapting the procedure according to U.S. Pat. No. 8,497,330 B2, column 22, lines 48, to 67. Example A-1 was slurried with hydrophobic fumed silica, MAO in toluene, and additional toluene, which was then introduced to the atomizing device as described for Example 1-4, to give Example A-3 as a powder.

A number of properties were determined for polymers. The results are reported in Tables 6, 9, 10, and 11. Catalyst productivity (grams polymer/gram catalyst-hour) was determined as a ratio of polymer produced to an amount of catalyst added to the reactor. Melt index (I2) was determined according to ASTM D1238 (190° C., 2.16 kg), melt index (I5) was determined according to ASTM D1238 (190° C., 5 kg), melt index (I21) was determined according to ASTM D1238 (190° C., 21.6 kg); Mw, Mn, Mz, and Mw/Mn were determined by GPC; molecular weight comonomer distribution index (MWCDI) was determined as discussed herein.

The polymerization utilized a pilot scale fluidized bed gas phase polymerization reactor that included a reactor vessel containing a fluidized bed of a powder of ethylene/alpha-olefin copolymer, and a distributor plate disposed above a bottom head, and defining a bottom gas inlet, and having an expanded section, or cyclone system, at the top of the reactor vessel to decrease resin fines that may escape from the fluidized bed. The expanded section defined a gas outlet. The reactor further included a compressor blower that was utilized to continuously cycle gas around from out of the gas outlet in the expanded section in the top of the reactor vessel through a cycle loop down to and into the bottom gas inlet of the reactor and through the distributor plate and fluidized bed. The reactor further included a cooling system that removed heat of polymerization and maintained the fluidized bed at a target temperature. Compositions of gases such as ethylene, alpha-olefin, and hydrogen were fed into the reactor and monitored by an in-line gas chromatograph in the cycle loop to maintain specific concentrations that were used to control polymer properties. The spray-dried catalyst was fed as a slurry or dry powder into the reactor from high pressure devices, wherein the slurry was fed via a syringe pump and the dry powder was fed via a metered disk. The catalyst entered the fluidized bed in the lower ⅓ of the bed height. The polymerization system weighed the fluidized bed and included isolation ports that discharged the polymerization product from the reactor vessel in response to an increase of the fluidized bed weight as the polymerization reaction proceeded.

TABLE 5

| | Gas-Phase | Gas-Phase | Gas-Phase |
|---|---|---|---|
| | Continuous | Continuous | Continuous |
| | Polymer | Polymer | Polymer |
| | 1 | 2 | 3 |
| Catalyst | SDMAO | Comparative | SDMAO |
| | | Example A-3 | |
| Reactor Temp | 85 | 90 | 85 |
| [° C.] | | | |
| H2/C2 | 0.0001096 | 0.0001608 | 0.0000770 |
| (molar ratio) | | | |
| H2/PPM/C2 | 1.10 | 1.61 | 0.77 |
| % Ratio | | | |
| Avg. C2PP | 100 | 100 | 100 |
| [psi] | | | |
| Avg. C6/C2 | 0.0028 | 0.0028 | 0.0028 |
| (molar ratio) | | | |
| Reactor Pressure | 348 | 348 | 349 |
| (psi) | | | |
| Isopentane | 13.1 | 14.2 | 12.7 |
| (mol %) | | | |
| Slurry Cat Feed | 18.00 | 14.18 | 30.00 |
| Rate (cc/hr) | | | |
| Catalyst Solids | 14 | 16 | 14 |
| (wt %) | | | |
| Trim Component | Example 1-3 | none | Comparative |
| | | | Example B-1 |
| Trim Solution Feed | 106.5 | — | 185.8 |
| (lb/hr) | | | |
| Avg. Bed Weight | 132.6 | 98.0 | 99.0 |
| (lb) | | | |
| Production Rate | 27.16 | 36.18 | 43.84 |
| (lb/hr) | | | |
| Productivity | 4092 | 7304 | 2375 |
| (lb/lb) | | | |
| Average of I₂ Melt | — | 0.16 | — |
| Index | | | |
| (dg/min) | | | |
| Avg. Bed Weight | 132.6 | 98.0 | 99.0 |
| (lb) | | | |
| Average of I₂₁ Flow | 0.52 | 3.14 | 0.27 |
| Index (dg/min) | | | |
| Average of Melt | - | 20.30 | - |
| Flow Ratio | | | |
| (I₂₁/I₂) | | | |
| Average of Density | 0.9283 | 0.9302 | 0.9269 |
| (g/cc) | | | |

TABLE 6

| | Gas-Phase | Gas-Phase | Gas-Phase |
|---|---|---|---|
| | Continuous | Continuous | Continuous |
| | Polymer | Polymer | Polymer |
| | 1 | 2 | 3 |
| Mn | 106,534 | 73,499 | 131,629 |
| Mw | 355,639 | 217,821 | 435,616 |
| Mz | 899,605 | 495,113 | 1,140,739 |
| Peak molecular | 249,126 | 150,227 | 322,909 |
| weight | | | |
| PDI | 3.34 | 2.96 | 3.31 |
| Mz/Mw | 2.53 | 2.27 | 2.62 |
| wt % C6 | 1.2 | 1.4 | 1.7 |
| SCB/ 1000TC | 1.53 | 1.81 | 1.99 |
| MWCDI | 1.58 | 0.03 | 0.82 |
| Tm (° C.) | 133.1 | 127.5 | 132.9 |
| ΔHm (J/g) | 119.7 | 140.5 | 109.2 |

Tables 5 and 6 refer to polymer that was made utilizing Example 1-3 as a trim onto SDMAO. Each of the Gas-Phase Continuous Polymers 1-3 were targeted to be the same density and have a similar molecular weight at I₂₁ of 0.5.

Gas-Phase Continuous Polymer 2, made with Comparative Example A-2, could only make a polymer at 3 Fl (~218 k Mw) which is the upper limit of that catalysts molecular weight capability. Gas-Phase Continuous Polymer 1 and Gas-Phase Continuous Polymer 2 have similar Fl and Mw (small difference due to slightly higher H₂/C₂ for Gas-Phase Continuous Polymer 1) and density. Density is roughly equivalent for each polymer and the polymers in Tables 5 and 6 can be referred to as having a medium density.

Comparing Gas-Phase Continuous Polymer 1, made with Example 1-3, to Gas-Phase Continuous Polymers 2-3 shows that Example 1-3 is capable of making an advantaged BOCD polymer in the medium density range and at very high molecular weight (I₂₁<1, Mw>300,000). The data of Table 6 illustrate that polymer made with Example 1-3 had an improved, i.e., greater, molecular weight comonomer distribution index (MWCDI) as compared to polymer made with both Comparative Example A-3 and Comparative Example C-1.

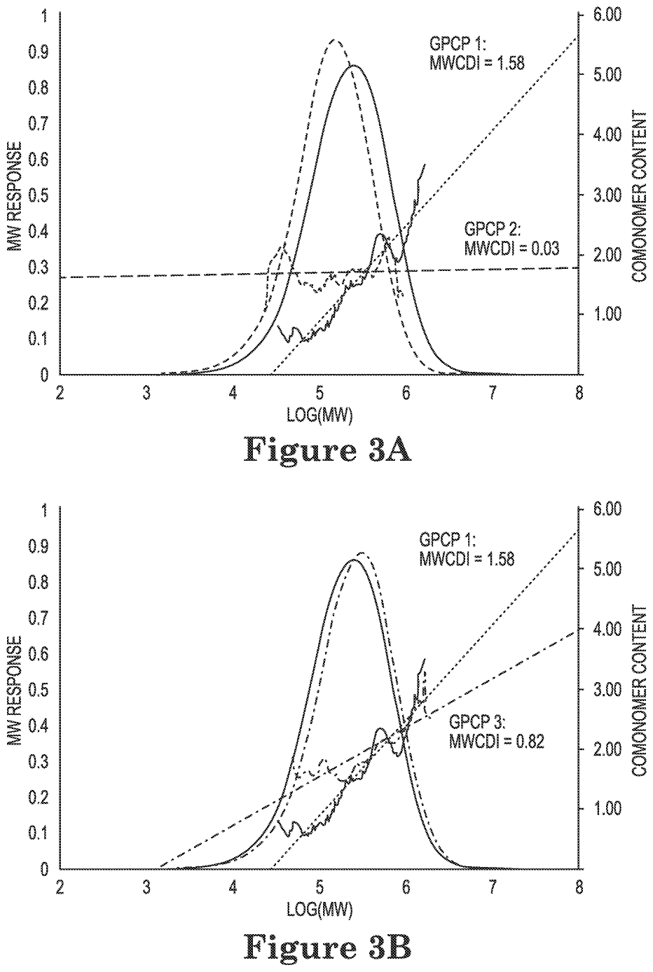

FIG. 3A shows a data plot utilized to determine MWCDI Gas-Phase Continuous Polymer 1 (MWCDI=1.58) and a data plot utilized to determine MWCDI for Gas-Phase Continuous Polymer 2 (MWCDI=0.03), as reported in Table 6.

FIG. 3B shows a data plot utilized to determine MWCDI Gas-Phase Continuous Polymer 1 (MWCDI=1.58) and a data plot utilized to determine MWCDI for Gas-Phase Continuous Polymer 3 (MWCDI=0.82), as reported in Table 6.

TABLE 7

| | Gas-Phase | Gas-Phase | Gas-Phase | Gas-Phase | Gas-Phase |
|---|---|---|---|---|---|
| | Continuous | Continuous | Continuous | Continuous | Continuous |
| | Polymer | Polymer | Polymer | Polymer | Polymer |
| | 4 | 5 | 6 | 7 | 8 |
| Catalyst | Example | SDMAO + | Example | Example | Example |
| | 1-4 | Example | 1-4 | 1-4 | 1-4 |
| | | 1-3 trim | | | |
| Metallocene | Example | Example | Example | Example | Example |
| Component | 1-1 | 1-3 | 1-1 | 1-1 | 1-1 |
| Avg. Reactor | 74.97 | 79.96 | 80.00 | 79.99 | 80.00 |
| Temp [° C.] | | | | | |
| Avg. H2/C2 | 0.0005 | 0.000504 | 0.000999 | 0.002073 | 0.000644 |
| Molar Ratio | | | | | |
| Avg. | 4.992 | 5.041 | 9.987 | 20.733 | 6.438 |
| H2/PPM/C2% | | | | | |
| Ratio | | | | | |
| Avg. C2PP | 191.4 | 131.2 | 130.0 | 129.2 | 130.3 |
| [psi] | | | | | |
| Avg. C6/C2 | 0.0152 | 0.0224 | 0.0088 | 0.0074 | 0.0002 |
| (molar Ratio) | | | | | |
| Slurry Cat | 16 | 22 | 15 | 14 | 11 |
| Feed Rate | | | | | |
| (cc/hr) | | | | | |
| Avg. Reactor | 350 | 350 | 350 | 350 | 350 |
| pressure | | | | | |
| (psi) | | | | | |
| Avg. | 4.07 | 6.65 | 3.04 | 3.19 | 2.67 |
| Residence | | | | | |
| Time | | | | | |
| Avg. Bed | 124.03 | 75.33 | 138.74 | 144.84 | 126.73 |
| Weight [[b] | | | | | |
| Productivity | 4,602 | 1,202 | 7,109 | 7,569 | 10,192 |
| (lb/lb) | | | | | |
| I2 Melt Index | 0.208 | 0.364 | 6.915 | 62.973 | 2.1824 |
| [dg/min] | | | | | |
| I21 Flow | 7.575 | 11.33 | 143.648 | 1309.857 | 36.5517 |
| Index [dg/min] | | | | | |
| Melt Flow | 36.30 | 31.13 | 20.78 | 20.82 | 16.75 |
| Ratio (I21/I2) | | | | | |
| Density [g/cc] | 0.9189 | 0.9234 | 0.9355 | 0.9422 | 0.9551 |

TABLE 8

| | Gas-Phase | Gas-Phase | Gas-Phase | Gas-Phase | Gas-Phase |
|---|---|---|---|---|---|
| | Continuous | Continuous | Continuous | Continuous | Continuous |
| | Polymer | Polymer | Polymer | Polymer | Polymer |
| | 9 | 10 | 11 | 12 | 13 |
| Catalyst | Comparative | VP-100 | VP-100 | VP-100 | VP-100 |
| | Example | | | | |
| | A-3 | | | | |
| Metallocene | Example | Example | Example | Example | Example |
| Component | A-1 | A-1 | A-1 | A-1 | A-1 |
| Avg. Reactor | 85 | 95.0 | 95.0 | 90 | 85 |
| Temp [° C.] | | | | | |
| Avg. H2/C2 | 0.00054 | 0.0008 | 0.0004 | 0.000351 | 0.0004 |
| Molar Ratio | | | | | |
| Avg. | 5.4 | 8.5 | 4.4 | 3.51 | 4.31 |
| H2/PPM/C2% | | | | | |
| Ratio | | | | | |
| Avg. C2PP | 200 | 200.0 | 202.8 | 200 | 100 |
| [psi] | | | | | |
| Avg. C6/C2 | 0.0127 | 0.0067 | 0.0020 | 0.0044 | 0.0005 |
| (molar Ratio) | | | | | |
| Avg. Reactor | 350 | 349 | 349 | 347 | 349 |
| Pressure (psi) | | | | | |
| Slurry Cat | 5.50 | (dry feed) | (dry feed) | (dry feed) | (dry feed) |
| Feed Rate | | | | | |
| (cc/hr) | | | | | |
| Avg. | 3.1 | 2.7 | 2.5 | 2.7 | 2.8 |
| Residence | | | | | |
| Time | | | | | |
| Avg. Bed | 146 | 106.0 | 107.5 | 147 | 108 |
| Weight [[b] | | | | | |
| Productivity | 4,158 | 3,842 | 3,530 | 8,100 | |
| (lb/lb) | | | | | |
| I2 Melt Index | 0.33 | 7.1845 | 1.7879 | 3.389 | 3.71 |
| [dg/min] | | | | | |
| I21 Flow | 6.732 | 131.3951 | 35.2308 | 57.27 | 64.74 |
| Index [dg/min] | | | | | |
| Melt Flow | 20.4 | 18.3 | 19.7 | 16.9 | 17.5 |
| Ratio (I21/I2) | | | | | |
| Density [g/cc] | 0.9188 | 0.9349 | 0.9433 | 0.9391 | 0.9525 |

Gas-Phase Continuous Polymers 10-13 were made with XCAT VP-100, obtained from Univation Technologies, LLC, and utilized as a Comparative Example catalyst herein. VP-100 is a supported catalyst comprised of the symmetrical hafnium metallocene Example A-1.

TABLE 9

| | Gas-Phase | Gas-Phase | Gas-Phase |
|---|---|---|---|
| | Continuous | Continuous | Continuous |
| | Polymer | Polymer | Polymer |
| | 4 | 5 | 9 |
| I2 Melt Index | 0.208 | 0.364 | 0.33 |
| [dg/min] | | | |
| I21 Flow Index | 7.575 | 11.33 | 6.732 |
| [dg/min] | | | |
| Melt Flow Ratio | 36.3 | 31.13 | 20.4 |
| (I21/I2) | | | |
| Density [g/cc] | 0.9189 | 0.9234 | 0.9188 |
| Mn | 47,140 | 38,096 | 47901 |
| Mw | 195,127 | 148,915 | 157,738 |
| Mz | 645,780 | 460,523 | 377,041 |
| Peak molecular | 72,444 | 67,608 | 91280 |
| weight | | | |
| PDI | 4.14 | 3.91 | 3.29 |
| Mz/Mw | 3.31 | 3.09 | 2.39 |
| wt % C6 | 9.87 | 7.65 | 6.26 |
| SCB/ 1000TC | 16.45 | 12.74 | 7.14 |
| MWCDI | 7.34 | 5.4 | 2.51 |
| Tm (° C.) | 8.00 | 5.49 | 3.35 |
| ΔHm (J/g) | 120.7 | 132.8 | 119.1 |
| Melt Strength, | 14.7 | 13.8 | 9.5 |
| Force (cN) | | | |
| Drawability (mm/s) | 99.3 | 79.2 | 61.3 |
| V 0.1, Pa · s | 74689 | 57169 | 21147 |
| V 100, Pa · s | 2968 | 2526 | 3380 |
| RR = V 0.1/V 100 | 25.16 | 22.63 | 6.26 |

The Gas-Phase Continuous Polymers of Table 9 can be referred to as linear low density polymers.

The data of Table 9 illustrate that polymer made with Example 1-4 and Example 1-3/SDMAO each had an improved, i.e., greater, molecular weight comonomer distribution index (MWCDI) as compared to polymer made with Comparative Example A-3, at equivalent density and MI.

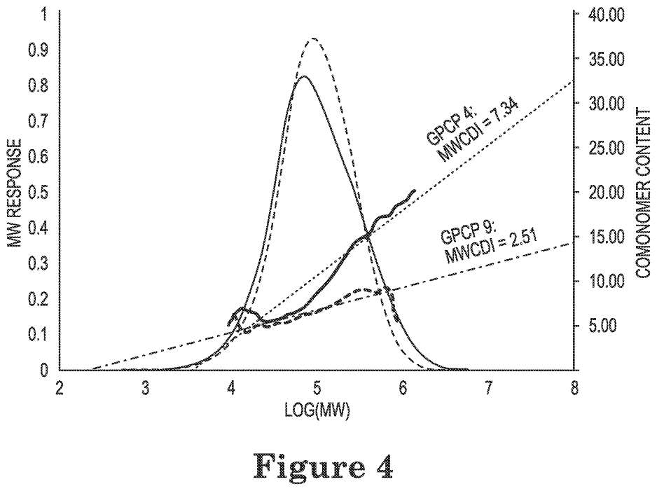

FIG. 4 shows a data plot utilized to determine MWCDI Gas-Phase Continuous Polymer 4 (MWCDI=7.34) and a data plot utilized to determine MWCDI for Gas-Phase Continuous Polymer 9 (MWCDI=2.51), as reported in Table 9.

The Gas-Phase Continuous Polymers 4 and 5 made with Example 1-4 and Example 1-3/SDMAO each had an improved melt strength, i,e., greater melt strength of 14.2 cN and 13.8 cN, respectively, compared to the melt strength of the Gas-Phase Continuous Polymer 9 made by the comparative Example A-1 of 9.5 cN. The Gas-Phase Continuous Polymers 4 and 5 additionally have improved melt flow ratio (I21/I2), i.e., greater melt flow ratio (I21/I2), and broader PDI than that of the comparative Gas-Phase Continuous Polymer 9 made by the comparative Example A-3. Both Gas-Phase Continuous Polymers 4 and 5 have improved high shear viscosities (V100), i.e. decreased high shear viscosities (V100) despite having significantly higher low shear viscosities (V0.1) than the comparative Gas-Phase Continuous Polymer 9. A lower high shear viscosities (V100) is typically associated with improved processing rates which is advantageous. The rheology ratio (RR) of the Gas-Phase Continuous Polymers 4 and 5 made with catalyst Example 1-4 and Example 1-3/SDMAO are significantly greater than the RR of the Gas-Phase Continuous Polymer 9 made by the comparative Example A-3. A higher RR indicates that the polymers have a higher degree of sheer thinning. Taken together, the improved melt strength, increased sheer thinning, larger MFR, broader PDI, and lower high sheer viscosities (V100) for the Gas-Phase Continuous Polymers 4 and 5 made with catalyst Example 1-4 and Example 1-3/SDMAO all indicate improved processability for applications in this density range, such as film, compared to the Gas-Phase Continuous Polymer 9 made by the comparative Example A-3.

The data in Table 9 indicate that the catalysts Example 1-4 and Example 1-3/SDMAO can produce polymers having both improved mechanical properties as well as having improved processability, which is a very advantaged balance of properties.

TABLE 10

| | Gas-Phase | Gas-Phase | Gas-Phase |
|---|---|---|---|
| | Continuous | Continuous | Continuous |
| | Polymer | Polymer | Polymer |
| | 6 | 10 | 12 |
| I2 Melt Index | 6.915 | 7.1845 | 3.389 |
| [dg/min] | | | |
| I21 Flow Index | 143.648 | 131.3951 | 57.27 |
| [dg/min] | | | |
| Melt Flow Ratio | 20.78 | 18.3 | 16.9 |
| (I21/I2) | | | |
| Density [g/cc] | 0.9355 | 0.9349 | 0.9391 |
| Mn | 23,222 | 23,359 | 31790 |
| Mw | 65,553 | 66,082 | 84892 |
| Mz | 150,880 | 129,920 | 168285 |
| Peak molecular | 46,774 | 53,703 | 56,234 |
| weight | | | |
| PDI | 2.82 | 2.83 | 2.67 |
| Mz/Mw | 2.3 | 1.97 | 1.98 |
| wt % C6 | 4.62 | 3.21 | 1.7 |
| SCB/ 1000TC | 7.7 | 4.14 | 2.36 |
| MWCDI | 3.56 | 1.17 | 0.79 |
| Tm (° C.) | 123.3 | 122.71 | I |
| ΔHm (J/g) | 162 | 173.1 | I |
| V 0.1, Pa.s | 1771 | 1084 | 2321 |
| V 100, Pa.s | 622 | 640 | 1103 |
| RR1 = V 0.1/V 100 | 2.85 | 1.69 | 2.10 |

The Gas-Phase Continuous Polymers of Table 10 can be referred to as medium density polymers.

The data of Table 10 illustrate that polymer made with Example 1-4 a had an improved, i.e., greater, molecular weight comonomer distribution index (MWCDI) as compared to polymer made with VP-100.

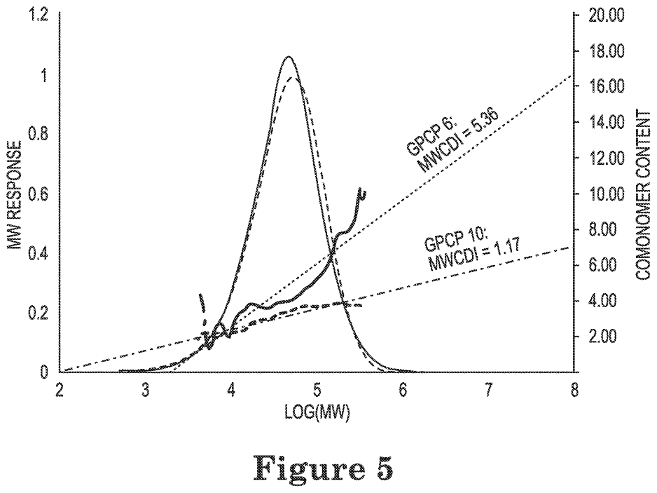

FIG. 5 shows a data plot utilized to determine MWCDI Gas-Phase Continuous Polymer 6 (MWCDI=5.36) and a data plot utilized to determine MWCDI for Gas-Phase Continuous Polymer 10 (MWCDI=1.17), as reported in Table 9.

Gas-Phase Continuous Polymer 6 has improved high shear viscosity (V100), i.e. decreased high shear viscosity (V100) despite having significantly higher low shear viscosity (V0.1) than the comparative Gas-Phase Continuous Polymers 10 and 12. The Gas-Phase Continuous Polymer 6, made by utilizing Example 1-4, also has an improved rheology ratio (RR), i.e., greater rheology ratio (RR) than those of Gas-Phase Continuous Polymers 10 and 12 made by the comparative catalyst VP-100.

TABLE 11

| | Gas-Phase | Gas-Phase | Gas-Phase | Gas-Phase |
|---|---|---|---|---|
| | Continuous | Continuous | Continuous | Continuous |
| | Polymer | Polymer | Polymer | Polymer |
| | 7 | 11 | 8 | 13 |
| I2 Melt Index | 62.973 | 1.7879 | 2.1824 | 3.72 |
| [dg/min] | | | | |
| I21 Flow Index | 1309.857 | 35.2308 | 36.5517 | 67.9 |
| [dg/min] | | | | |
| Melt Flow Ratio | 20.82 | 19.7 | 16.75 | 18.25 |
| (I21/I2) | | | | |
| Density [g/cc] | 0.9422 | 0.9433 | 0.9551 | 0.952 |
| Mn | 13,982 | 35,743 | 33,802 | 30,378 |
| Mw | 37,551 | 95,785 | 97,436 | 80,450 |
| Mz | 75,877 | 193,261 | 75,858 | 171,027 |
| Peak molecular | 33,113 | 75,858 | 226,233 | 56,234 |
| weight | | | | |
| PDI | 2.69 | 2.68 | 2.88 | 2.65 |
| Mz/Mw | 2.02 | 2.02 | 2.32 | 2.13 |
| wt % C6 | 5.03 | 0.93 | 0.46 | 0.91 |
| SCB/ 1000TC | 8.38 | 1.44 | 0.69 | 1.08 |
| MWCDI | 2.65 | 0.34 | 0.26 | −0.21 |
| Tm (° C.) | 2.31 | 0.3 | 0.29 | −0.45 |
| ΔHm (J/g) | 124.2 | 128.58 | 133.33 | 131.18 |

The Gas-Phase Continuous Polymers of Table 11 can be referred to as high density polymers.

The data of Table 11 illustrate that polymer made with Example 1-1 a had an improved, i.e., greater, molecular weight comonomer distribution index (MWCDI) as compared to polymer made with VP-100 at a given density range. For instance, the Gas-Phase Continuous Polymer 7 made with Example 1-4 has greater MWCDI (2.65) than the Gas-Phase Continuous Polymer 11 made with VP-100 (MWCDI=0.34), and both polymers have a density of 0.942-0.943 g/cc. Likewise, at even higher densities the Gas-Phase Continuous Polymer 8 made with Examples 1-4 has a greater MWCDI (0.26) at 0.9551 g/cc than the Gas-Phase Continuous Polymer 13 made with VP-100 (MWCDI=0.34) at 0.952 g/cc.

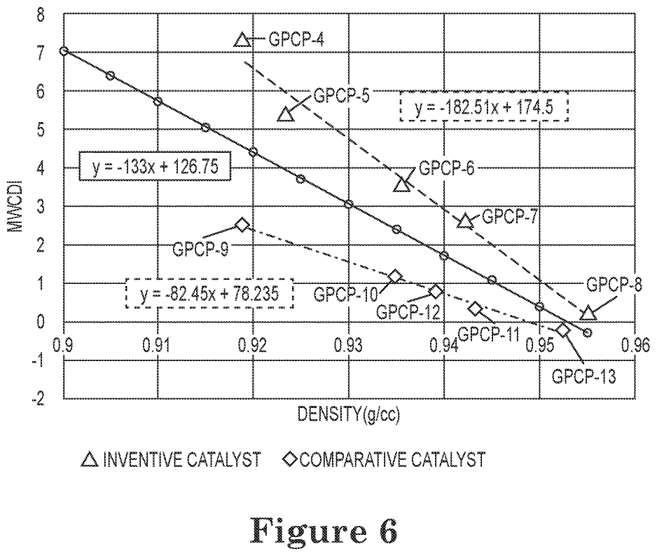

FIG. 6 shows data plots of the molecular weight comonomer distribution index (MWCDI) vs density in accordance a number of embodiments of the present disclosure. FIG. 6 is a plot of the molecular weight comonomer distribution index (MWCDI) vs density for the inventive Gas-Phase Continuous Polymers 4 through 8, and the comparative Gas-Phase Continuous Polymers 9 through 13. The Gas-Phase Continuous Polymers 4 through 8 were all made by a spray dried catalyst (trim or otherwise) containing the asymmetrical hafnium metallocene having one n-propylcyclopentadienyl ligand and one unsubstituted cyclopentadienyl ligand, i.e. Examples 1-1 and 1-3. The Gas-Phase Continuous Polymers 9 through 13 were all made by a spray dried catalyst or supported commercial catalyst VP-100, all containing the comparative symmetrical hafnium metallocene having two n-propylcyclopentadienyl ligand, i.e. Example A-1.

The data of FIG. 6 illustrate that the polymers made by catalysts comprised of Examples 1-1 and 1-3 give an improved, i.e. greater MWCDI at a given density, than polymers made by catalysts comprised of the comparative symmetrical metallocene Example A-1.

Examples 1-1 and 1-3 produced polymers that had a MWCDI vs Density relationship such that: MWCDI=−182.51*Density+174.5. The comparative catalyst produced polymers having a MWCDI vs Density relationship such that: MWCDI=−82.45*Density+78.235.

In some embodiments the inventive catalysts give a MWCDI vs Density relationship such that: MWCDI>−133*Density+126.75.

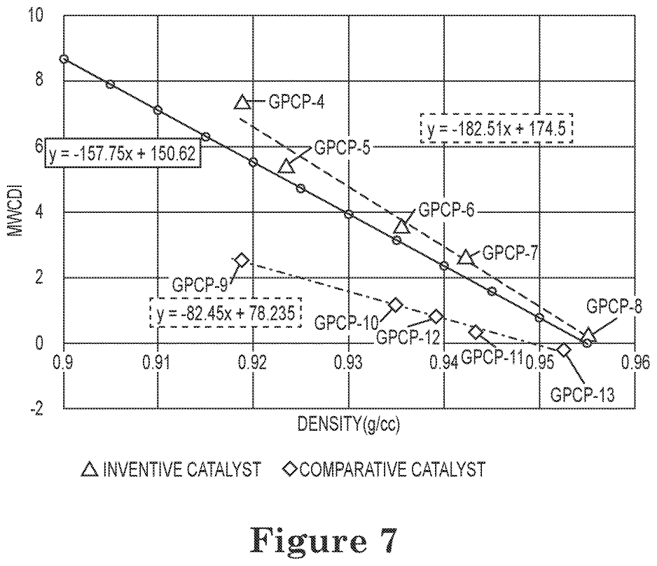

FIG. 7 shows data plots of the molecular weight comonomer distribution index (MWCDI) vs density in accordance a number of embodiments of the present disclosure. FIG. 7 is a plot of the molecular weight comonomer distribution index (MWCDI) vs density for the inventive Gas-Phase Continuous Polymers 4 through 8, and the comparative Gas-Phase Continuous Polymers 9 through 13. The Gas-Phase Continuous Polymers 4 through 8 were all made by a spray dried catalyst (trim or otherwise) containing the asymmetrical hafnium metallocene having one n-propylcyclopentadienyl ligand and one unsubstituted cyclopentadienyl ligand, i.e. Examples 1-1 and 1-3. The Gas-Phase Continuous Polymers 9 through 13 were all made by a spray dried catalyst or supported commercial catalyst VP-100, all containing the comparative symmetrical hafnium metallocene having two n-propylcyclopentadienyl ligand, i.e. Example A-1. One or more embodiments provide, as shown in FIG. 7, that the inventive catalysts provide a MWCDI vs Density relationship such that: MWCDI>−157.75*Density+150.62 as shown by FIG. 7.

1. An asymmetrical hafnium metallocene represented by structure (I): 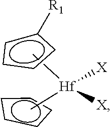
wherein R¹ is a (C₁-C₈)alkyl; and each X is independently a leaving group.

2. The asymmetrical hafnium metallocene of claim 1, wherein each X is independently a leaving group selected from a halogen, (C₁-C₅)alkyl, CH₂SiMe₃, and benzyl.

3. The asymmetrical hafnium metallocene of claim 1, wherein R¹ is a (C₃-C₄)alkyl and each X is Cl or each X is CH₃.

4. The asymmetrical hafnium metallocene of claim 1, selected from the group consisting of:
hafnium asymmetrical metallocenes represented by structures (II) to (V):

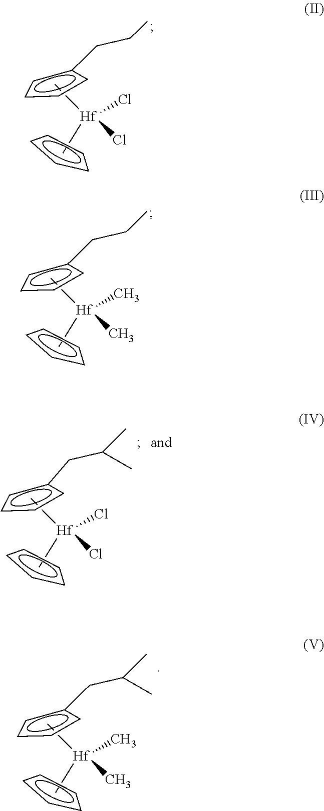

5. The asymmetrical hafnium metallocene of claim 1, selected from the group consisting of:
hafnium asymmetrical metallocenes represented by structures (II) to (III):

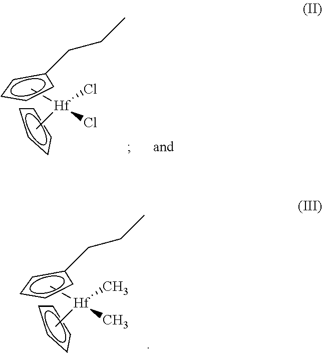

6. The asymmetrical hafnium metallocene of claim 1, selected from the group consisting of:
hafnium asymmetrical metallocenes represented by structures (IV) to (V):

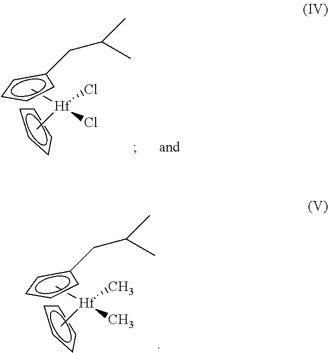

7. A method of synthesizing the asymmetrical hafnium metallocene of claim 1 wherein each X is Cl, the method comprising either:
contacting a hafnium complex with an alkali metal complex, wherein the alkali metal complex is represented by the following structure: 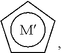
wherein M′ is lithium, sodium, or potassium, and
the hafnium complex is represented by one of the following structures: 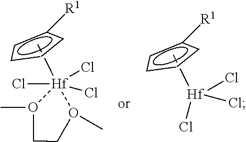
or
contacting a hafnium complex with an alkali metal complex, wherein the alkali metal complex is represented by the following structure: 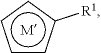
wherein M′ is lithium, sodium, or potassium; and
the hafnium complex is represented by the following structure: 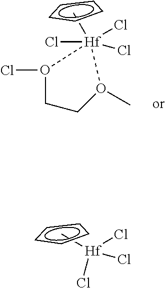
to make the asymmetrical hafnium metallocene.

8. The method of claim 7 comprising contacting the asymmetrical hafnium metallocene with two mole equivalents of an organomagnesium halide of formula RMg(halide) or one mole equivalent of R₂Mg, wherein R is (C₁-C₅)alkyl, CH₂SiMe₃, or benzyl; and the halide is Cl or Br, to make the asymmetrical hafnium metallocene of structure (I) wherein each X is (C₁-C₅)alkyl, CH₂SiMe₃, or benzyl.

9. A metallocene catalyst composition comprising:
the asymmetrical hafnium metallocene of claim 1,
an activator.

10. The metallocene catalyst composition of claim 9 further comprising a support.

11. The metallocene catalyst composition of claim 10, wherein the composition is a spray-dried metallocene catalyst composition.

12. (canceled)

13. A method of making a polyolefin polymer, the method comprising:
polymerizing at least one olefin monomer with either the metallocene catalyst composition of claim 9, to make the polyolefin polymer; wherein preferably the at least one olefin monomer comprises ethylene and, optionally, a comonomer selected from the group consisting of propene and a (C₄-C₂₀)alpha-olefin.

14. The method of claim 13, wherein the at least one olefin monomer comprises ethylene and the comonomer; and wherein the polyolefin polymer has a molecular weight comonomer distribution index (MWCDI) from 0.10 to 10.00, as measured by the MWCDI Test Method described herein; wherein preferably the comonomer is selected from the group consisting of 1-butene, 1-hexene, and 1-octene.

15. A polyolefin polymer made by the method of claim 13.

16. The polyolefin polymer of claim 15, wherein the polyolefin polymer has MWCDI vs density relationship such that: MWCDI>−133*Density+126.75.

17. The polyolefin polymer of claim 15, wherein the polyolefin polymer has MWCDI vs density relationship such that: MWCDI>−157.75*Density+150.62.

18. A method of making a polyolefin polymer, the method comprising:
polymerizing at least one olefin monomer with a spray dried asymmetrical hafnium metallocene catalyst composition to make the polyolefin polymer; wherein at least one olefin monomer comprises ethylene and, optionally, a comonomer selected from the group consisting of propene and a (C₄-C₂₀)alpha-olefin, wherein the polyolefin polymer has a molecular weight comonomer distribution index (MWCDI) from 0.10 to 10.00 and a MWCDI vs density relationship such that: MWCDI>−133*Density+126.75.

19. The method of claim 18, wherein the polyolefin polymer has a MWCDI vs density relationship such that: MWCDI>−157.75*Density+150.62.
